(19) United States
(12) Patent Application Publication
(10) Pub. No.: US 2025/0021242 A1
(43) Pub. Date: Jan. 16, 2025

(54) PROCESSOR WITH HARDWARE-INTEGRATED MEMORY ACCESS PROTECTION

(71) Applicant: Texas Instruments Incorporated, Dallas, TX (US)

(72) Inventors: David Foley, Sugar Land, TX (US); Saya Goud Langadi, Sugar Land, TX (US); Alexander Tessarolo, Lindfield (AU); Venkatesh Natarajan, Bangalore (IN)

(21) Appl. No.: 18/771,764

(22) Filed: Jul. 12, 2024

Related U.S. Application Data
(60) Provisional application No. 63/513,447, filed on Jul. 13, 2023.

(51) Int. Cl. G06F 3/06

(52) U.S. Cl. CPC G06F 3/0622; G06F 3/0637; G06F 3/0679

(57) ABSTRACT

In described examples, an integrated circuit (IC) includes a memory and a processor coupled to the memory. The processor is configured to execute a discontinuity instruction, which specifies a memory address, to transition from executing according to a first stack pointer to executing according to a second stack pointer. The first stack pointer is copied from an active stack register to an inactive first stack pointer register. The processor determines whether the specified memory address stores a stack entry instruction that corresponds to the discontinuity instruction. If it does, the second stack pointer is copied from the inactive second stack pointer register to the active stack register, and the processor executes the stack entry instruction and begins execution according to the second stack pointer.

### CROSS-REFERENCE TO RELATED APPLICATIONS

This application claims the benefit of, and claims priority to, U.S. Provisional Patent Application No. 63/513,447, filed Jul. 13, 2023.

### TECHNICAL FIELD

This application relates generally to safe and secure operation of a processor and a memory, and more particularly to hardware integration of memory access protection.

### BACKGROUND

Industries may establish a wide range of safety requirements. Some example safety requirements stipulate freedom from interference (FFI) between functions. FFI requires functions performing different safety level tasks within an application to keep a fault that has occurred in a lower safety level function from corrupting a higher safety level function. For example, International Organization for Standardization (ISO) standard 26262 defines FFI as “absence of cascading failures between two or more elements that could lead to the violation of a safety requirement.” An example safety requirement in the ISO 26262 context is that execution or failure of a function within Automotive Safety Integrity Level B (ASIL-B), corresponding to a lower safety level, cannot corrupt execution of a function within ASIL-D, corresponding to a higher safety level.

Security requirements may stipulate separate execution environments such that a successful attack on one part of the application does not result in access to or manipulation of other parts of the application. For example, cryptographic keys must be kept secret and an associated security application must continue to run correctly even if a front-end communication interface is compromised, such as by code error or by third-party attack. The code of different execution environments may also be owned by different parties with different update and debug permissions.

Context switching refers to switching between different software processes or threads. A context switch can require transitioning between data and processes with different safety requirements and at different security levels. In some examples, each different task (or software context) is preceded by a software configuration process that can include security configuration such as firewall configuration, and then the processor runs the task code. The operating system switches between tasks responsive to a timer, partitioning task execution over time. In some examples, real-time processing requires control loops with fast response times, so that an allowable idle time in which to perform a context switch may be relatively short, such as two hundred clock cycles.

### SUMMARY

In described examples, an integrated circuit (IC) includes a memory and a processor coupled to the memory. The processor is configured to execute a discontinuity instruction, which specifies a memory address, to transition from executing according to a first stack pointer to executing according to a second stack pointer. The first stack pointer is copied from an active stack register to an inactive first stack pointer register. The processor determines whether the specified memory address stores a stack entry instruction that corresponds to the discontinuity instruction. If it does, the second stack pointer is copied from the inactive second stack pointer register to the active stack register, and the processor executes the stack entry instruction and begins execution according to the second stack pointer.

### BRIEF DESCRIPTION OF THE DRAWINGS

FIG. 1A is a first graph of example permissions association trees for access protection registers, LINKS, STACKs, and ZONEs.

FIG. 1B is a second graph of alternative example permissions association trees for APRs, LINKS, STACKs, and ZONEs.

FIG. 2 is an example processing system with a processor, a safety and security unit (SSU), and a memory and peripherals (MAP) block.

FIG. 3A is a first flow diagram for an example process for processing an instruction using the processing system of FIG. 2.

FIG. 3B is a second flow diagram continuing the example process of FIG. 3A for processing an instruction using the processing system of FIG. 2.

FIG. 3C is a third flow diagram continuing the example process of FIGS. 3A and 3B for processing an instruction using the processing system of FIG. 2.

FIG. 3D is a fourth flow diagram continuing the example process of FIGS. 3A, 3B, and 3C for processing an instruction using the processing system of FIG. 2.

FIG. 4 is a first example grouping of APRs with LINKs to determine which APRs will grant read and/or write permissions to those LINKs.

FIG. 5 is a second example grouping of APRs with LINKs to determine which APRs will grant read and/or write permissions to those LINKs.

FIG. 6 is a third example grouping of APRs to associate the APRs with respective LINKS.

FIG. 7 is an example set of memories of the MAP block of FIG. 2.

FIG. 8 is a table of example instruction names and corresponding functionality descriptions for transitioning from execution by the processing system of FIG. 2 according to a first STACK, to execution according to a second, different STACK.

FIG. 9 is an example set of instructions that includes a protected call instruction across a STACK boundary and corresponding return instructions for execution by the processing system of FIG. 2.

FIG. 10 is a table illustrating an example protected call stack supporting operation of the processing system of FIG. 2.

FIG. 11A is a flow diagram of an example process for transferring process control from a first STACK to a second STACK according to a protected call instruction or a protected branch instruction executed by the processing system of FIG. 2.

FIG. 11B is a flow diagram of an example process for transferring process control from a second STACK to a first STACK according to a return instruction following a protected call instruction according to FIG. 11A.

FIG. 12 is a table illustrating an example protected interrupt stack supporting operation of the processing system of FIG. 2.

FIG. 13A is a flow diagram of an example process for transferring process control across a STACK boundary according to an interrupt and performing an interrupt service routine.

FIG. 13B is a flow diagram of an example process for returning process control to a previously executing process after the processor finishes executing an ISR in response to a protected interrupt according to FIG. 13A.

FIG. 14 is a functional block diagram of an example system for determining permissions for a debug instruction according to the processing system of FIG. 2.

FIG. 15 is a flow diagram of an example process for determining permissions for a debug instruction according to the system of FIG. 14.

FIG. 16 is a functional block diagram of an example system for determining permissions for and performing firmware updates according to the processing system of FIG. 2.

FIG. 17A is a first flow diagram of an example firmware update process for the system of FIG. 16.

FIG. 17B is a second flow diagram continuing the example firmware update process according to the system of FIG. 16.

FIG. 17C is a third flow diagram continuing the example firmware update process according to the system of FIG. 16.

### DETAILED DESCRIPTION

Multiple related approaches, which can be combined in potentially synergistic ways, are described hereinbelow in Sections I, II, III, and IV. The titles of these sections are not limiting. Section I relates to permissions association trees that include access protection registers (APRs), LINKS, STACKs, and ZONEs. Permissions association trees are used to control safety and security policies for a processing system that includes some or all of a processor, memory, peripherals, and a safety and security unit (SSU). Section II relates to use of APRs and LINKs to control memory and peripheral access permissions and execution permissions for software processes. Section III relates to STACKs, which are used for control of switching between stack pointers used to separately track data corresponding to separate software contexts to enforce process isolation. Section IV relates to ZONEs, which are used to enforce user-level permission limitations, such as for debugging and firmware updating.

In some examples, a LINK is a grouping of memory ranges with an identifier so that other memory ranges can give that identifier, and accordingly the grouped memory ranges, memory access permissions. A STACK is a grouping of memory ranges into an isolated execution region and may be used so that only code from a currently-active STACK can be executed. Switching from a first STACK being active to a second STACK being active can accordingly be limited to a defined, secure process. A ZONE is a grouping of memory ranges at a user level so that functionality such as debugging and firmware updating can be performed safely and limited to a subset of the memory ranges corresponding to a user credential.

Herein, some structures or signals that are distinct but related have reference numbers that use a [number] [dash] [number] format, such as LINK2 104-2, LINK3 104-3, and LINK4 104-4. In some examples, these structures or signals are referred to generally, in the singular or as a group, using the [number] and without the [dash] [letter], such as LINKs 104. Also, the same reference numbers or other reference designators are used in the drawings to designate features that are related structurally and/or functionally.

### I. Permissions Association Trees and Example Processor System

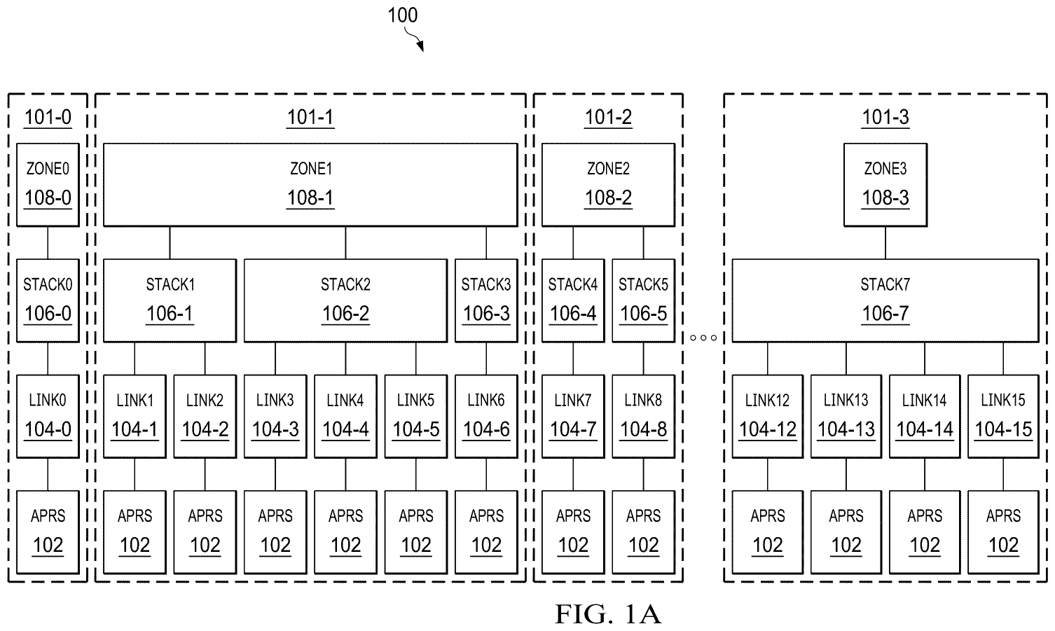

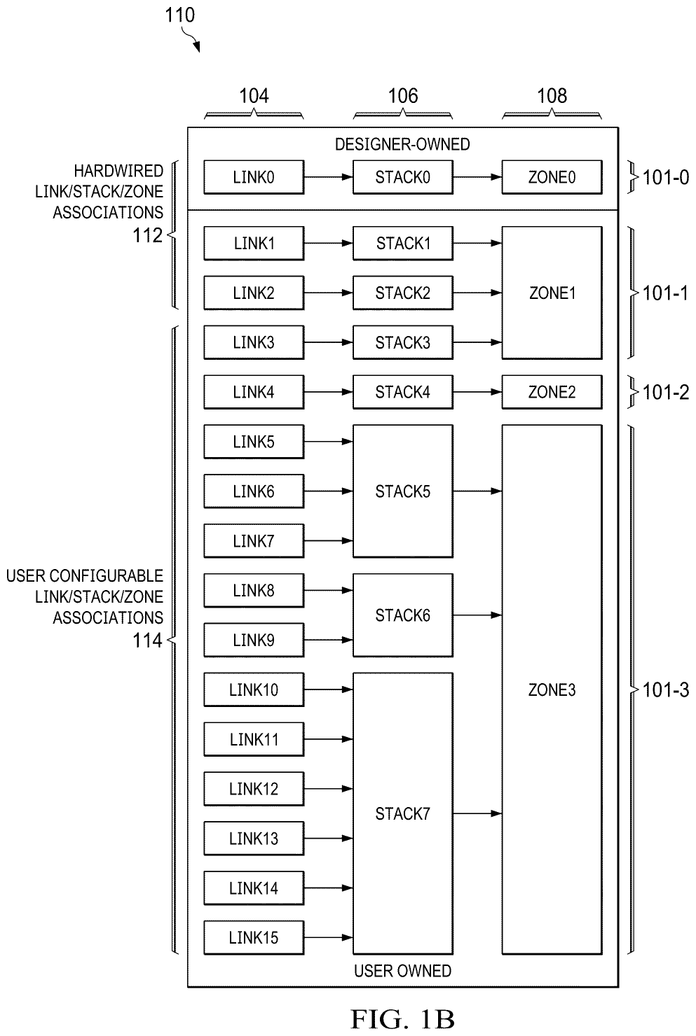

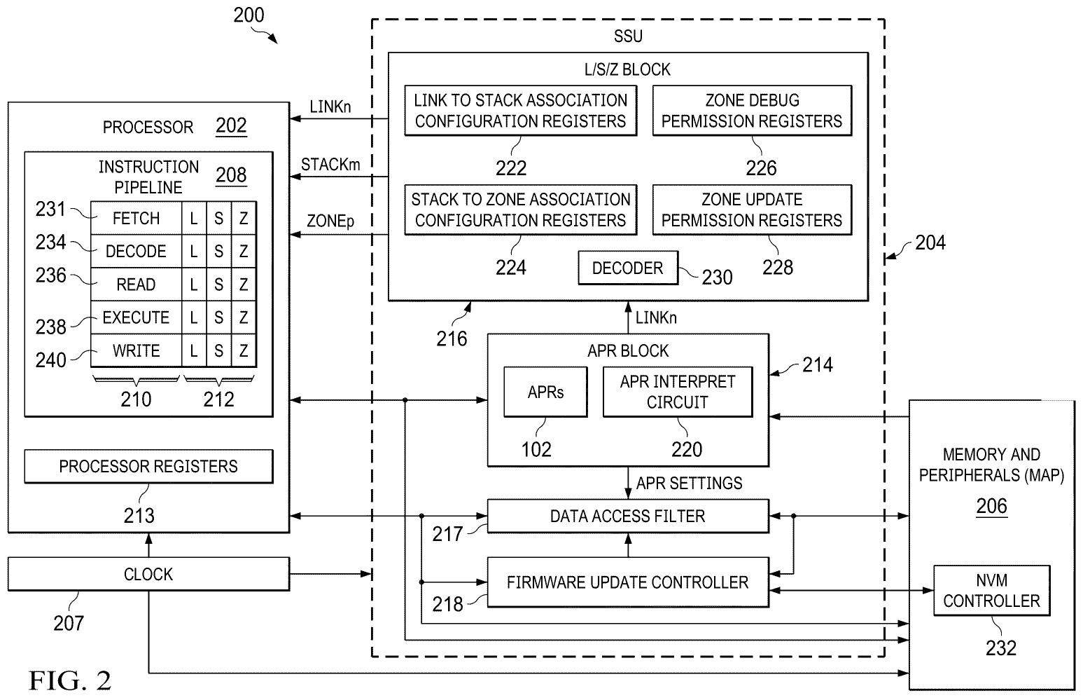

FIG. 1A is a first graph 100 of example permissions association trees 101 for APRs 102, LINKs 104, STACKs 106, and ZONEs 108. The permissions association trees 101 correspond to hardware, and to software and hardware configuration settings, on an integrated circuit (IC), and relate to operation of a processor 202 in communication with a memory and peripherals block 206 (see FIG. 2). Each “APRS 102” item in the graph 100 corresponds to one or more APRs 102. Accordingly, each of the permissions association trees 101 respectively includes one or more APRs 102, one or more LINKs 104, one or more STACKs 106, and one ZONE 108. Safety and security settings can be managed using permissions association trees 101.

The leaves of permissions association trees 101 correspond to APRs 102, and nodes in ascending levels of the permissions association trees 101 include, in order, LINKs 104, STACKs 106, and ZONEs 108 (FIGS. 1A and 1B). Accordingly, ZONEs 108 are the root nodes of respective permissions association trees 101. Together, a LINK 104, a STACK 106, and a ZONE 108 corresponding to a memory range defined by an APR 102, along with configuration settings stored in the APR 102, set a safety and security policy for that memory range.

APRs 102, LINKS 104, STACKs 106, and ZONEs 108 variously enable safety and security control at process, stack, and user levels, including for context switches, interrupts, transitions from execution using one stack pointer to execution using another stack pointer, debugging, and firmware updates. Security is automatically handled at a hardware level responsive to user-configurable settings in APRs 102 and in tables that manage tree 101 topology, accordingly, associations between the APRs 102, LINKs 104, STACKs 106, and ZONEs 108 that make up the trees 101. Debug and firmware update permissions can be set for different ZONEs 108 corresponding to different users, without compromising read, write, and execute permissions specified by different APRs 102 and LINKs 104 that together correspond to different processes.

Each APR 102 corresponds to a memory address range that may store data or instructions, or may correspond to memory for one or more peripherals. In some examples, memory ranges of APRs 102 are defined by a memory map which may index multiple types of memory, such as RAM, ROM, Flash, or other volatile or non-volatile memory. In some examples, memory for a peripheral corresponds to control register(s), an input or output data buffer, or other memory. In some examples, APRs 102 are not allowed to have overlapping memory ranges. In some examples, an individual APR 102 corresponds to an individual software function or to a set of consecutively-addressed memory ranges corresponding to one or more instances of a single type of peripheral.

Each APR 102 is associated with one LINK 104, each LINK 104 is associated with one STACK 106, and each STACK 106 is associated with one ZONE 108. One or more APRs 102 may be associated with each LINK 104, one or more LINKs 104 may be associated with each STACK 106, and one or more STACKs 106 may be associated with each ZONE 108. Thus, LINKs 104 are groups of APRs 102, STACKs 106 are groups of LINKs 104, and ZONEs 108 are groups of STACKs 106. In some examples, one or more instruction-related APRs 102 and/or data-related APRs 102 and/or peripheral-related APRs 102 are associated with a LINK 104. In some examples, one or more APRs 102, such as six APRs 102, may be associated with a LINK 104. The LINK 104, STACK 106, and ZONE 108 corresponding to an APR 102 together define a safety and security policy for that APR 102.

Each APR 102 stores an indicator specifying the LINK 104 associated with that APR 102, an execution permission setting, and read/write (R/W) permission settings corresponding to all available LINKs 104. APRs 102 can be populated by a user and organized by the user into LINKs 104, STACKs 106, and ZONEs 108 to enable fast, automatic, hardware-based enforcement of safety and security policies.

Accordingly, an APR 102 can serve some or all of multiple distinct purposes, some examples of which follow. First, the APR 102 determines data memory access permissions for a corresponding memory region so that each available LINK 104 can be given its own respective set of R/W access permissions. Second, the APR 102 stores the LINKID that other APRs 102 can use to determine whether instructions executed from memory associated with the APR 102 have R/W permission. Third, the execution permission setting (execute bit) stored by the APR 102 determines whether the memory region corresponding to the APR 102 is allowed to function as program memory, so that data stored within that memory region may be executed as instructions (code).

Functional stack pointers are registers that store a first available memory address or a memory address of a last added element in an area of memory referred to herein as a functional stack. In some examples, a functional stack can store arguments, local variables, processor state data, and/or pointers to (and/or pointers to memory addresses of) variables, other pointers, structures, or constants. Herein, a functional stack refers to the set of memory addresses, and accordingly the set of data elements stored in corresponding memory locations, that are referenced by a functional stack pointer, its increment history, and corresponding offsets. For example, a compiler will understand that compiled code will put local variable x at a functional stack pointer address, variable y at a functional stack pointer+1 address (a next address location after the address storing x), and variable z at a functional stack pointer+2 address. In this example, an offset for variable x equals zero, an offset for variable y equals one, and an offset for variable z equals two. In some examples, the registers in which the functional stack pointers are stored are located in system memory or in a memory of the processor 202 such as the processor registers 213 (FIG. 2).

Herein, the security architecture enables different, segregated memory regions, each tracked by a corresponding functional stack pointer indexing a functional stack, to be used to maintain different, separate contexts of processor execution. An execution context and its respective functional stack correspond to a STACK 106, will be referred to as that STACK 106. Accordingly, a STACK 106 references both associations to one or more corresponding LINKs 104 and a ZONE 108 within a permissions association tree 101, and also a corresponding execution context and functional stack that can store various data for that execution context (as described above).

Accordingly, a STACK 106 associates one or more different software contexts (respectively corresponding to different LINKs 104) within a controlled-access (for example, secure) environment, with the functional stack corresponding to the STACK 106 that holds various data elements specific to that controlled-access environment. In some examples, a STACK 106 corresponds to a portion of all executable code stored on a device that uses a set of memory and peripherals to perform a corresponding coordinated application function. In some examples, functional stacks that correspond to STACKs 106 are secure stacks.

In some examples, incrementing a functional stack pointer is performed as part of execution of an instruction for storing a data value. In some examples, executing an instruction for storing a data value includes storing the data value at the address pointed to by the current functional stack pointer, and incrementing the functional stack pointer to the next memory address. Herein, storing a memory address of a data element in a functional stack is referred to as adding the data element to the functional stack.

Different ZONEs 108 correspond to, for example, different users or different debug or firmware update contexts. In some examples, ZONEs 108 can be used to improve or ensure safety of an allocation of firmware update granularity. When an update is performed according to permissions granted with respect to one ZONE 108, it may be sufficient to revalidate firmware integrity only with respect to that ZONE 108. This is because ZONE-related firmware update permissions isolate memory updated according to the permissions granted according to the ZONE 108 from memory for which firmware update is not permitted according to that ZONE 108. Accordingly, by design, firmware update of a non-volatile memory (or other memory) region associated with a first ZONE 108 does not interfere with non-volatile memory (or other memory) regions associated with other ZONEs 108.

Accordingly, a LINK 104 can be described as a grouping of APRs 102 corresponding to a task or process or thread, a STACK 106 can be described as a grouping of LINKs 104 corresponding to a functional stack pointer, and a ZONE 108 can be described as a grouping of STACKs 106 corresponding to a user, or corresponding to a debug or firmware update context. In some examples, LINKs 104 enable process-level safety, STACKs 106 enable higher level safety to ensure process integrity and also enforce intended device functionality to support security, and ZONEs 108 enable user-level security via password or cryptographic control.

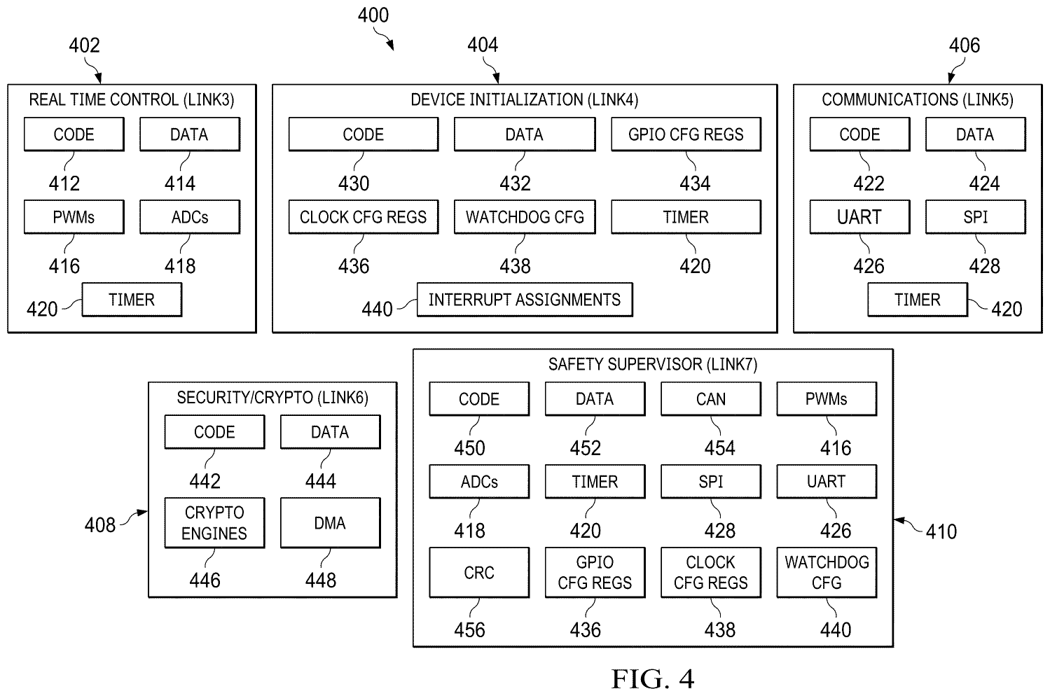

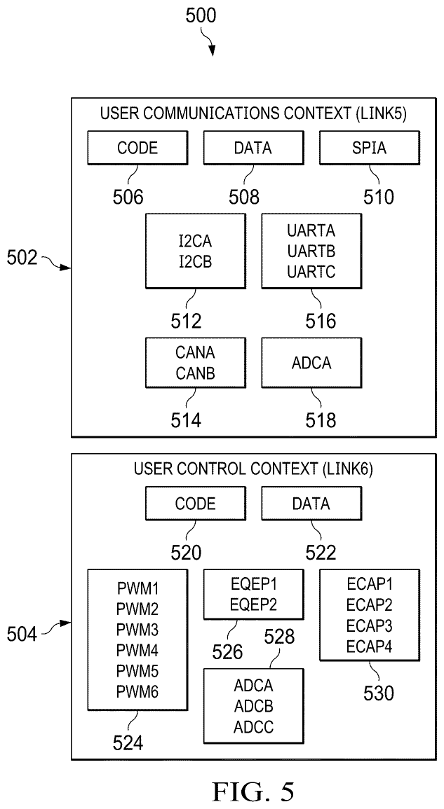

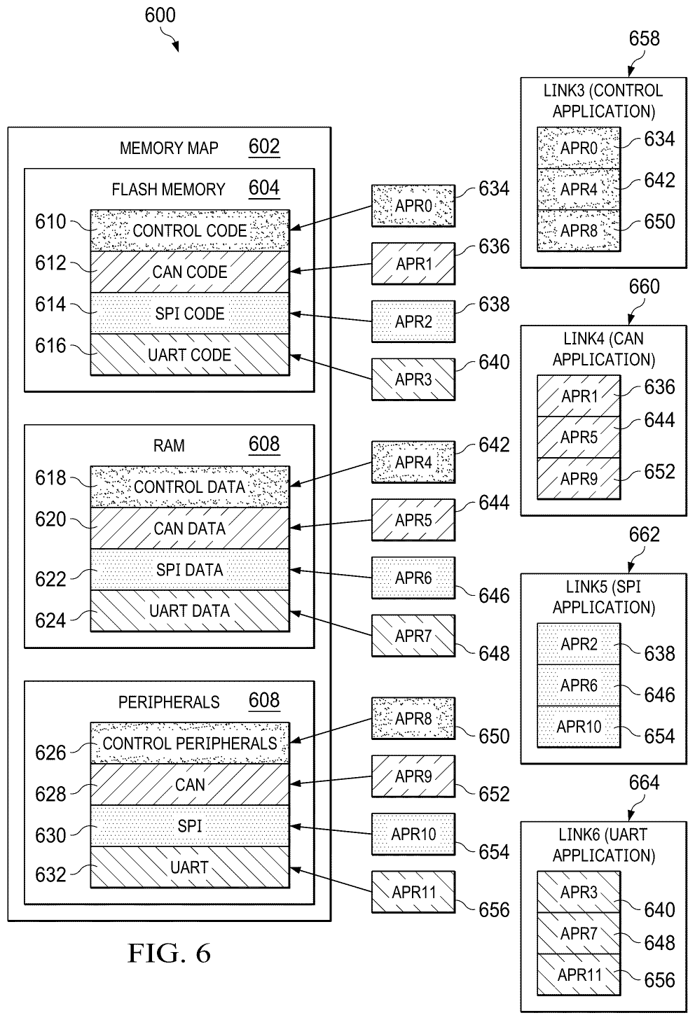

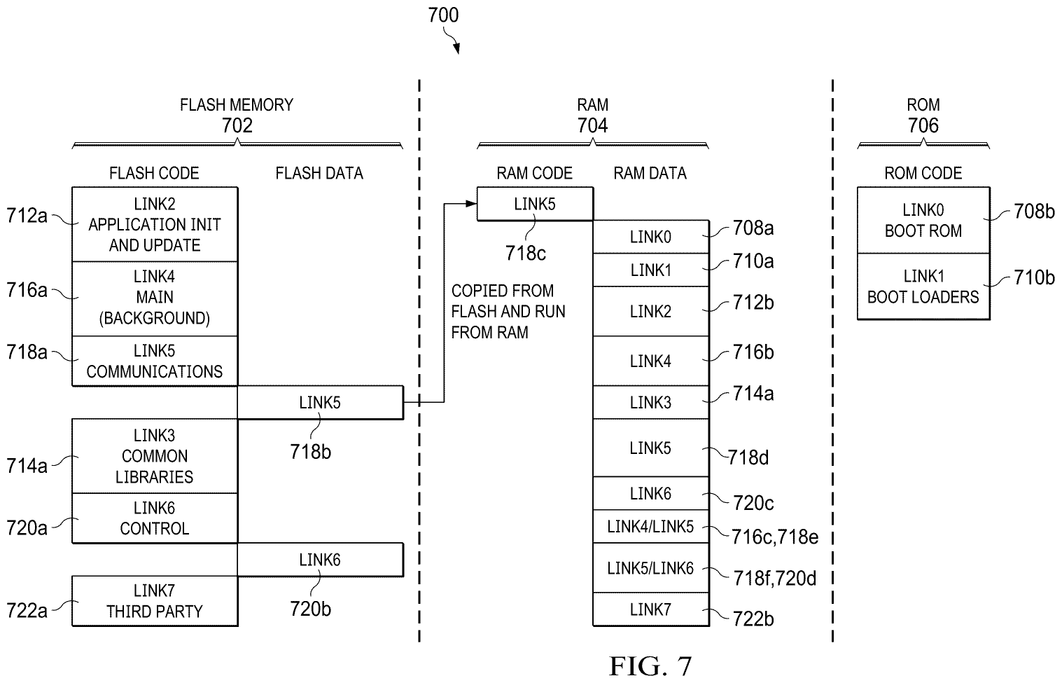

Use of APRs 102 and LINKs 104 to control R/W and execution access to memory and peripherals is described with respect to FIG. 2. Example allocations of APRs 102 corresponding to different applications to respective LINKs 104 are described with respect to FIGS. 4 and 5. An example allocation of APRs 102 corresponding to different peripherals or groups of peripherals associated with respective LINKs 104 is described with respect to FIG. 6. An example memory partition with respect to different LINKs 104 is described with respect to FIG. 7.

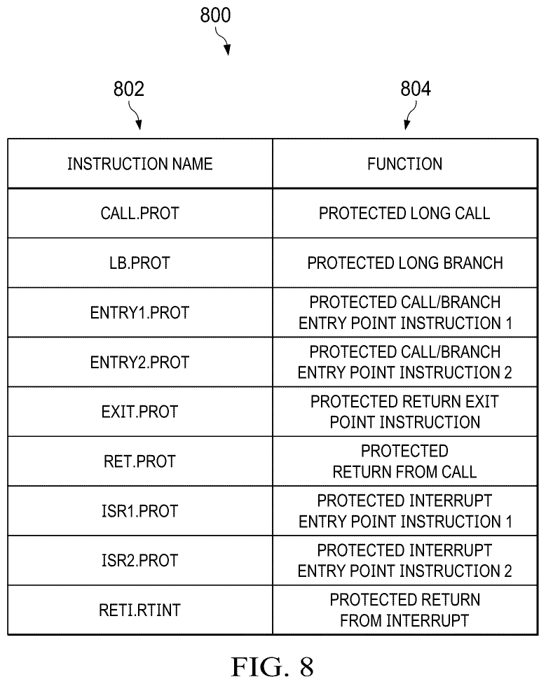

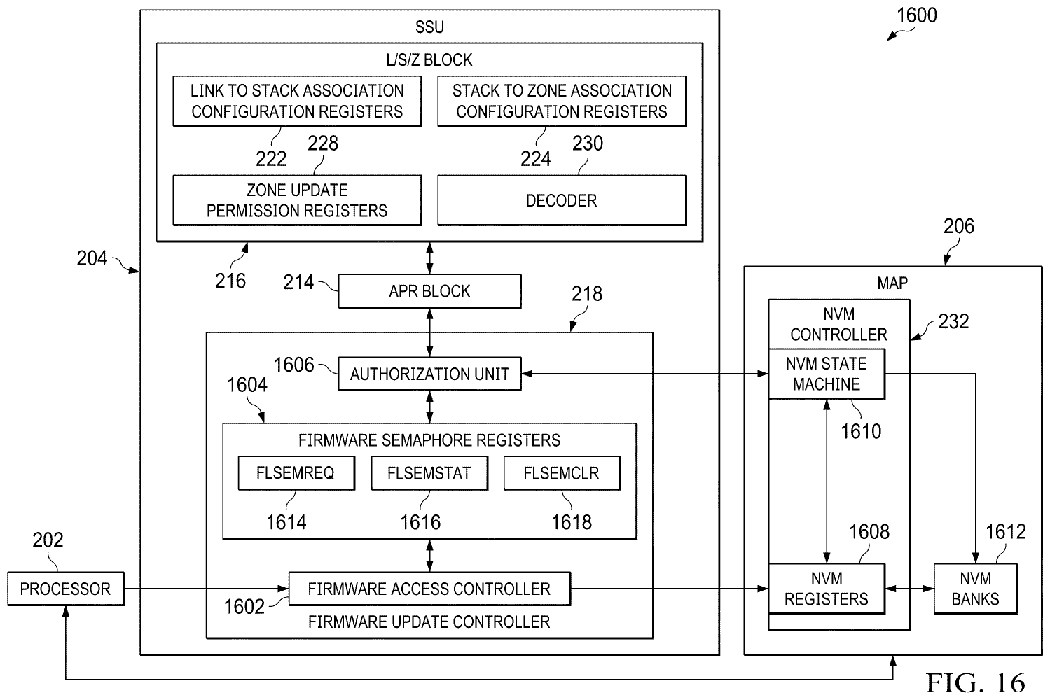

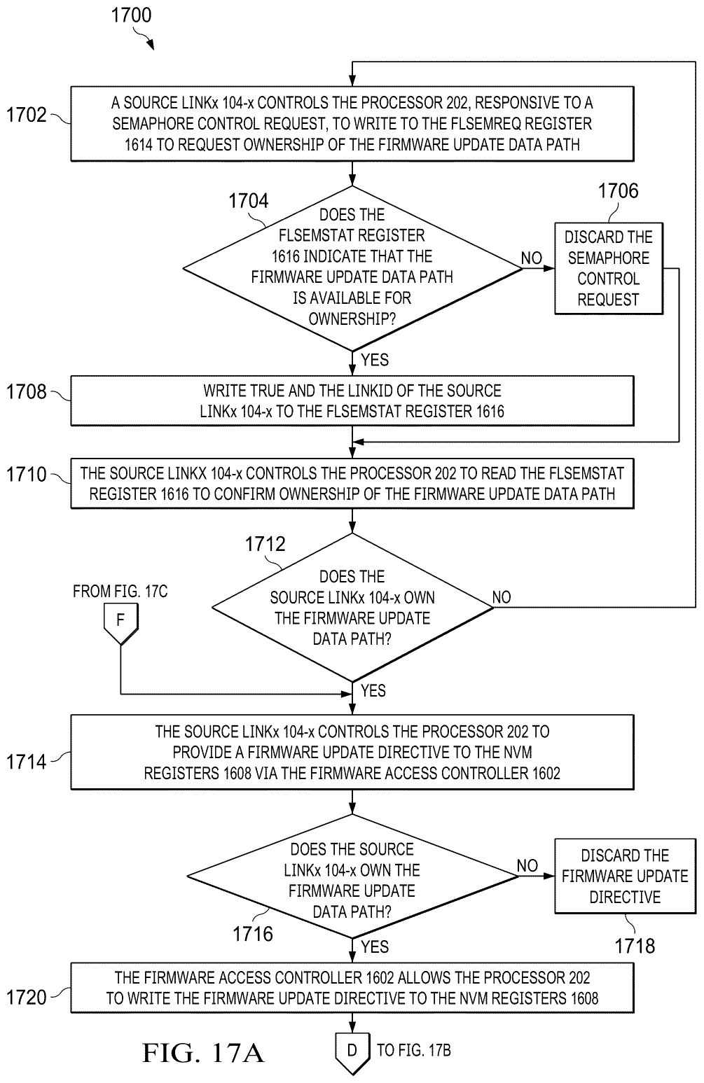

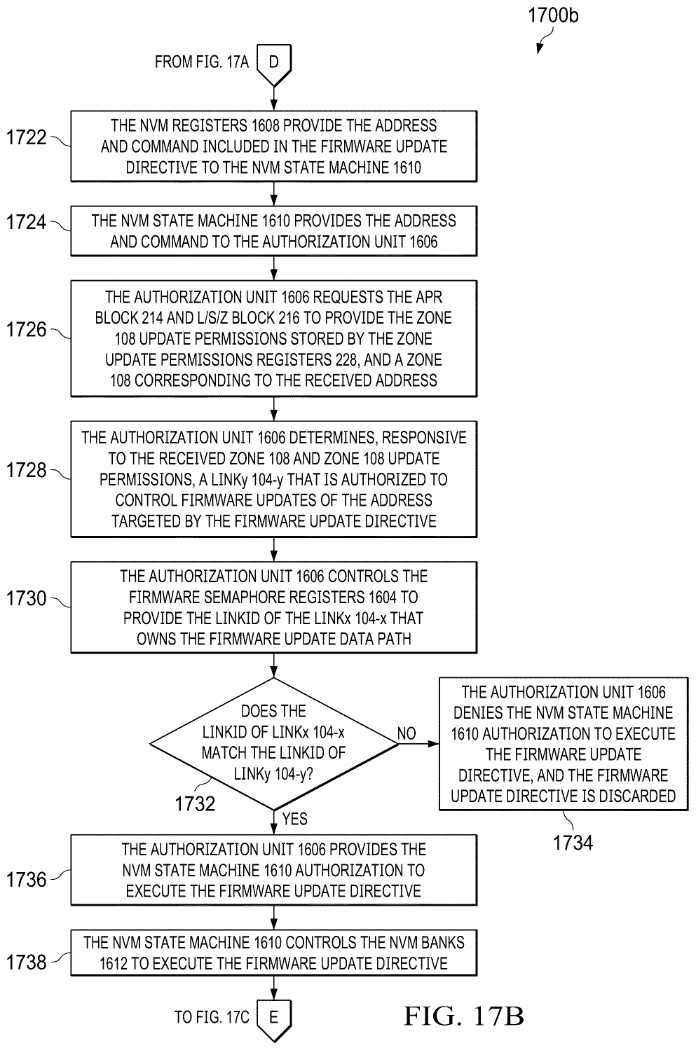

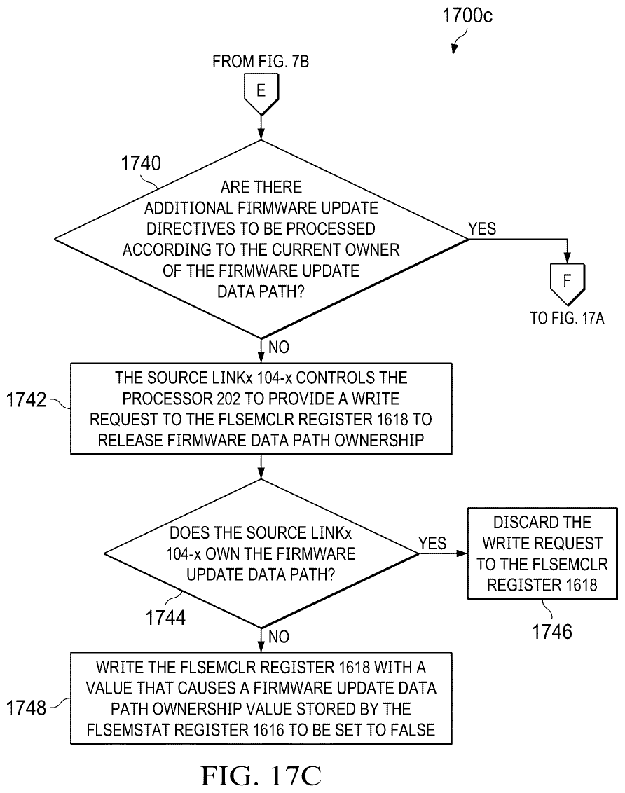

Transitioning from execution using a first functional stack pointer, corresponding to a first STACK 106, to execution using a second functional stack pointer, corresponding to a second STACK 106, is described with respect to FIGS. 8 to 13. Control of debug permissions using ZONEs 108 is described with respect to FIGS. 16 and 17. Control of firmware update permissions using ZONEs 108 is described with respect to FIGS. 18 and 19.

In an example corresponding to the graph 100, there are sixty-four APRs 102, sixteen LINKs 104 numbered LINK0 through LINK15, eight STACKs 106 numbered STACK0 through STACK7, and four ZONEs 108 numbered ZONE0 to ZONE3. Each permissions association tree 101 corresponds to a different ZONE 108, accordingly, to a different user. The graph 100 includes a first permissions association tree 101-0, a second permissions association tree 101-1, a third permissions association tree 101-2, and a fourth permissions association tree 101-3.

The first permissions association tree 101-0 includes one or more APRs 102, a first LINK (LINK0) 104-0, a first STACK (STACK0) 106-0, and a first ZONE (ZONE0) 108-0. LINK0 104-0 is associated with STACK0 106-0, which is associated with ZONE0 108-0. One or more APRs 102 is associated with each LINK 104 in FIGS. 1A and 1B.

The second permissions association tree 101-1 includes at least six APRs 102 (at least one for each LINK 104), a second LINK (LINK1) 104-1, a third LINK (LINK2) 104-2, a fourth LINK (LINK3) 104-3, a fifth LINK (LINK4) 104-4, a sixth LINK (LINK5) 104-5, a seventh LINK (LINK6) 104-6, a second STACK (STACK1) 106-1, a third STACK (STACK2) 106-2, a fourth STACK (STACK3) 106-3, and a second ZONE (ZONE1) 108-1. LINK1 104-1 and LINK2 104-2 are associated with STACK1 106-1. LINK3 104-3, LINK4 104-4, and LINK5 104-5 are associated with STACK2 106-2. LINK6 104-6 is associated with STACK3 106-3. STACK1 106-1, STACK2 106-2, and STACK3 106-3 are associated with ZONE1 108-1.

The third permissions association tree 101-2 includes at least two APRs 102, an eighth LINK (LINK7) 104-7, a ninth LINK (LINK8) 104-8, a fifth STACK (STACK4) 106-4, a sixth STACK (STACK5) 106-5, and a third ZONE (ZONE2) 108-2. LINK7 104-7 is associated with STACK4 106-4, and LINK8 104-8 is associated with STACK5 106-5. STACK4 106-4 and STACK5 106-5 are associated with ZONE2 108-2.

The fourth permissions association tree 101-3 includes at least four APRs 102, a thirteenth LINK (LINK12) 104-12, a fourteenth LINK (LINK13) 104-13, a fifteenth LINK (LINK14) 104-14, and a sixteenth LINK (LINK15 ) 104-15. LINK12 104-12, LINK13 104-13, LINK14 104-14, and LINK15 104-15 are associated with STACK7 106-7, which is associated with ZONE3 108-3.

Tenth through twelfth LINKs (LINK9 104-9, LINK 10 104-10, and LINK11 104-11) and a seventh STACK (STACK6) 106-6 are not shown. In an example, LINK9 104-9, LINK10 104-10, and LINK11 104-11 are associated with STACK6 106-6, which is associated with ZONE3 108-3. Alternatively, these LINKs 104 and STACK 106, and corresponding APRs 102, could be configured by the user to be associated with any of the other LINKs 104, STACKs 106, and ZONEs 108, to the extent that associations are not hardwired. An example of hardwired LINK 104, STACK 106, and ZONE 108 associations is described with respect to FIG. 1B, which also provides an alternative example grouping of LINKs 104, STACKs 106, and ZONEs 108 into permissions association trees 101.

In some examples, a STACK 106 includes LINKs 104 that are not consecutively numbered. For example, STACK1 106-1 can be associated with LINK1 104-1, LINK5 104-5, and LINK7 104-7, while not being associated with LINK2 104-2, LINK3 104-3, etc. In some examples, numbers (quantity) of APRs 102, LINKs 104, STACKs 106, and/or ZONEs 108 are configurable, such as using a LINK 104 designated as the root of trust (or other, similar, configuration process with appropriate access permissions, such as root of trust-equivalent permissions). In some examples, not all available APRs 102, LINKs 104, STACKs 106, or ZONEs 108 are used. Accordingly, in an example with up to sixty-four APRs 102, sixteen LINKs 104, eight STACKs 106, and four ZONEs 108, there may be less than or equal to sixty-four APRs 102, less than or equal to sixteen LINKs 104, less than or equal to eight STACKs 106, and less than or equal to four ZONEs 108. In some examples, there are different maximum numbers of APRs 102, LINKs 104, STACKs 106, or ZONEs 108.

Each APR 102 stores a start and an end of a memory address range, an indicator (such as a binary bit) of whether execution is enabled for the data stored in the memory address range, data read/write access permissions for each of the available LINKs 104, an identifier of a primary LINK 104 with execution rights to the APR 102 (a LINKID), and an execution enable bit. Note that some APRs 102 may point to memory ranges that store data or correspond to memory for a peripheral, and not executable code.

The LINKID is used when code is executed from a memory range associated with an APR 102 to indicate the source memory range for the executing code. The APR 102 associated with this source memory range is referred to as a source APR 102. The LINK 104 associated with the source APR 102, as indicated by the LINKID stored by the source APR 102, is referred to as a source LINK 104. The LINKID of the source LINK 104 is used to determine whether the source LINK 104 has required permissions to perform a read/write (and/or execution) with respect to data in a target memory range of the executing instruction. The APR 102 associated with this target memory range is referred to as a target APR 102, and the LINK 104 associated with the target APR 102, as indicated by the LINKID stored by the target APR 102, is referred to as a target LINK 104.

The execute bit stored by the source APR 102 is checked to determine whether the code being executed is properly executable. If not, a fault is provided to the processor. Read/write permissions for data stored in the memory range corresponding to the target APR 102 are determined by looking up the LINKID of the source LINK 104 in the configuration settings of the target APR 102. This enables source LINKs 104 that do not have appropriate permissions to be prevented from performing reads from or writes to memory within the range associated with the target APR 102. Accordingly, read/write and execute permissions can be determined by changing configuration settings within the APRs 102, and without establishing firewalls.

In some examples, memory ranges used to store data are marked non-executable to avoid safety and/or security breaches that may result from accidental or hostile execution of memory contents not intended to function as executable instructions.

In an example in which there are sixteen LINKs 104 corresponding to a processor, a LINKID may be a four bit field in a register of an APR 102. In this example, if data read/write permissions correspond to two bits, thirty-two bits (such as a thirty-two bit register) may be used to store data read/write permissions in an APR 102 to correspond to all sixteen LINKs 104. In an example, each two bit data read/write permission corresponds to no permission, read permission, write permission, or read and write permission.

FIG. 1B is a second graph 110 of alternative example permissions association trees 101 for APRs 102, LINKs 104, STACKs 106, and ZONEs 108. The graph 110 includes sixteen LINKS 104, eight STACKs 106, and four ZONEs 108. Sets of one or more APRs 102 are associated with each of the LINKs 104, but are not shown.

A first permissions association tree 101-0 includes LINK0 104, STACK0 106, and ZONE0 108. LINK0 104 is associated with STACK0 106, which is associated with ZONE0 108.

A second permissions association tree 101-1 includes LINK1 104, LINK2 104, LINK3 104, STACK1 106, STACK2 106, STACK3 106, and ZONE1 108. LINK1 104 is associated with STACK1 106, LINK2 104 is associated with STACK2 106, and LINK3 104 is associated with STACK3 . Accordingly, L/S/Z associations corresponding to STACK1 106 and STACK2 106 and associated LINKs 104 are hardwired, and L/S/Z associations corresponding to STACK3 106 and associated LINK 104 are user configurable. STACK1 106, STACK2 106, and STACK3 106 are associated with ZONE1 108.

A third permissions association trec 101-2 includes LINK4 104, STACK4 106, and ZONE2 108. LINK4 104 is associated with STACK4 106, which is associated with ZONE2 108.

A fourth permissions association tree 101-3 includes the remaining LINKs 104, STACKs 106, and ZONEs 108. LINK4 104 is associated with STACK4 106, which is associated with ZONE2 108. LINK5 104, LINK6 104, and LINK7 104 are associated with STACK5 106. LINK8 104 and LINK9 104 are associated with STACK6 106. LINK10 104, LINK11 104, LINK12 104, LINK13 104, LINK14 104, and LINK15 104 are associated with STACK7 106. STACK4 106, STACK5 106, STACK6 106, and STACK7 106 are associated with ZONE3 108.

A group of hardwired LINK/STACK/ZONE (L/S/Z) associations 112 includes LINK0 104, LINK1 104, LINK2 104, LINK3 104, STACK0 106, STACK1 106, STACK2 106, ZONE0 108, and ZONE1 108. A group of user configurable L/S/Z associations 114 includes the rest of the LINKs, STACKs, and ZONES 104, 106, and 108 shown in the graph 110, corresponding to LINK3 104 through LINK 15 104, STACK3 106 through STACK7 106, and ZONE1 108 through ZONE3 108. Accordingly, as further specified below, ZONE1 108 corresponds both to one or more of the hardwired L/S/Z associations 112 and to one or more of the user configurable L/S/Z associations 114.

In the illustrated example, the first permissions association tree 101-0 is designer owned because it includes certain boot read-only memory (ROM) code that is secure. In some examples, additional or other LINKs 104 (in addition to or other than LINK0 104) are associated with APRs 102 that reference ROM memory.

In an example, APR 102, LINK 104, STACK 106, and ZONE 108 configuration settings, including APR 102 contents and configuration settings establishing the permissions association trees 101, are stored in Flash or other non-volatile memory. These contents and settings are loaded into active registers by the LINK0 104 boot ROM. This enables security policy functionality prior to execution of user code, and prevents interference by a debug process with enforcement of L/S/Z-related security policy beginning early in a boot process. Accordingly, the first permissions association tree 101-0 is locked against reading, writing, or execution by a user, such as a customer (other than automatic execution at boot time). In some examples, this locking is password-based or cryptographic. In some examples, LINKs 104 in addition to or other than specific-numbered LINKs 104 referred to herein can be used for correspondingly described purposes or processes.

The second, third, and fourth permissions association trees 101-1, 101-2, and 101-3 are user owned. In an example, LINK1 104 includes boot ROM code that a user is allowed to debug, such as code for controlling a serial peripheral interface (SPI) or a controller area network (CAN) bus.

LINK2 104 is designated the root of trust for user software, and accordingly, includes special permissions. Specifically, LINK2 104 can write to APR 102 registers in any (in some examples, less than all) of the user owned permissions association trees 101-1, 101-2, and 101-3.

This enables an initial or oversight access user (such as a superuser) of an IC corresponding to the permissions trees to configure, in each user owned APR 102, R/W permissions per user owned LINK 104, start and end memory address ranges, LINKID, and the execution enable bit. LINK2 104 permissions also enables the superuser to configure, and accordingly rearrange, the user owned permissions trees 101, and to change debug permissions and firmware update permissions. Accordingly, in some examples, a security process is used to control or restrict access to LINK2 104.

In some examples, APRs 102 can be modified by code corresponding to LINK2 104 during runtime. For example, code downloaded to random access memory (RAM) can be marked non-executable. A LINK2 104 process can enable execution of the downloaded code after authentication of the downloaded code is completed.

FIG. 2 is an example processing system 200 with a processor 202, a safety and security unit (SSU) 204, a memory and peripherals (MAP) block 206, and a clock 207. The processor 202 includes an instruction pipeline 208 with multiple stages 210 and L/S/Z registers 212, and multiple processor registers 213. In some examples, the processor registers 213 include registers to track and support process flow, registers to store data retrieved responsive to read instructions, and registers to maintain process flow history (among many other functions). In some examples, process flow history is used to support certain types of returns from calls or interrupts, and/or to support determining permissions for certain types of instructions.

The SSU 204 includes an APR block 214, an L/S/Z block 216, a data access filter 217, and a firmware update controller 218. The MAP block 206 includes a non-volatile memory (NVM) controller (such as a Flash controller) 232. The APR block 214 includes APRs 102 and an APR interpret circuit 220. The L/S/Z block 216 includes LINK to STACK association configuration registers 222, STACK to ZONE association configuration registers 224, ZONE debug permission registers 226, ZONE update permission registers 228, and a decoder 230.

In some examples, a semiconductor die on or in which an IC is fabricated may include one or more processors 202 such as central processing units (CPUs), digital signal processors (DSPs), or microcontroller units (MCUs). In some examples, there is a single shared SSU 204 for a semiconductor die. Accordingly, in some examples, ZONEs 108 apply globally across the processor(s) on a semiconductor die. In some examples, there is one processor per non-volatile memory controller 232.

The processor 202 is communicatively connected to the MAP block 206, the APR block 214, the data access filter 217, and the firmware update controller 218. The APR block 214 provides outputs to the L/S/Z block 216 and the data access filter 217. The L/S/Z block 216 provides outputs to the processor 202. The MAP block 206 is communicatively connected to the processor 202, the APR block 214, the data access filter 217, and the firmware update controller 218. The clock 207 provides a clock signal to the processor 202, the SSU 204, and the MAP block 206.

In some examples, the MAP block 206 is connected to the processor 202 by a program-read data bus (PRDB) to provide instructions therethrough, and is connected to the data access filter 217 and the firmware update controller 218 by one or more of a data-read data bus (DRDB), a data write data bus (DWDB), a debug read data bus, or a debug write data bus. The MAP block 206 is connected to the APR block 214 by an address bus to provide an address of an instruction sent to the processor 202 responsive to a fetch request, to enable determination of corresponding LINK 104, STACK 106, and ZONE 108 information. Accordingly, this address bus connection enables the processor 202 (or SSU 204) to determine whether the APR 10

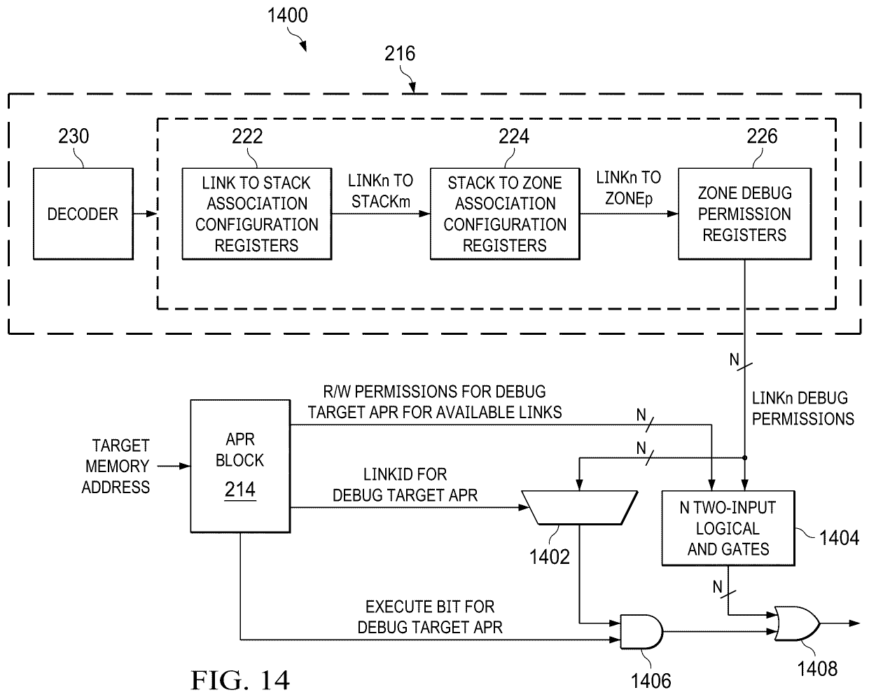

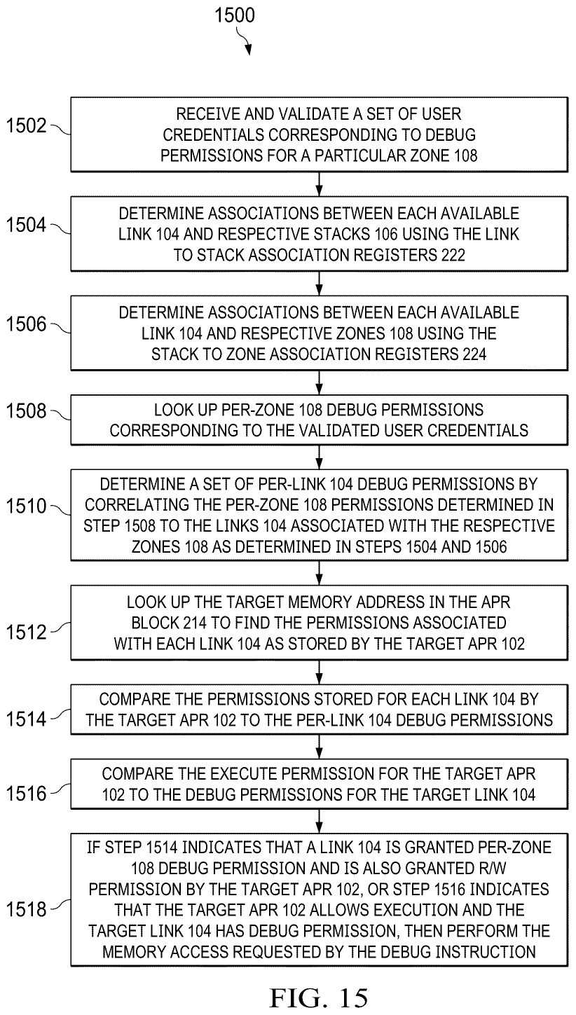

The firmware update controller 218 communicates with the non-volatile memory controller 232 to enable ZONE 108 based authorization for firmware updates, as further discussed with respect to FIGS. 14 and 15. In the illustrated example, firmware is stored in Flash memory. In some examples, other or additional non-volatile memory is used to store firmware. In such examples, the firmware update controller 218 communicates with a corresponding memory controller instead of or in addition to the non-volatile memory controller 232. In some examples, a bus has a different name or purpose or carries a portion of or more than one of these types of data. In some examples, additional, fewer, or different buses are used.

The processor 202 outputs to the MAP block 206 or to the APR block 214 via one or more of a program-read address bus (PRAB), a data-read address bus (DRAB), or a data-write address bus (DWAB). The processor 202 is two-way connected to the data access filter 217 via one or more of a DRDB or a DWDB. Other types of communication lines can also be used to implement each or any of the connections described herein, either instead of or in addition to the described buses. In some examples, a single bus can be used to implement multiple bus functionalities.

The permissions association trees 101 are determined by the APRs 102 in the APR block 214, and by the LINK to STACK and STACK to ZONE association configuration registers 222 and 224. The APRs 102 store corresponding LINKIDs that indicate LINKs 104 with which respective APRs 102 are associated. The LINK to STACK and STACK to ZONE association configuration registers 222 and 224 respectively determine STACKs 106 and ZONEs 108 corresponding to the LINKs 104 indicated by the LINKIDs stored in the APRs 102. In some examples, the LINK to STACK and STACK to ZONE association configuration registers 222 and 224 can be described as tables. Accordingly, LINK to STACK association configuration registers 222 are indexed by LINK 104 number (for example, 0 to 15), and STACK to ZONE association configuration registers 224 are indexed by STACK 106 number (for example, 0 to 7).

The L/S/Z registers 212 of the instruction pipeline 208 store L/S/Z values corresponding to the instruction being processed by a corresponding stage 210. In pipeline processing order, the stages 210 include one or more instruction fetch stages (fetch) 231, one or more instruction decode stages (decode) 234, one or more read stages 236, one or more execute stages 238, and one or more write stages 240.

### II. Use of APRs and LINKs for Process Permissions Control

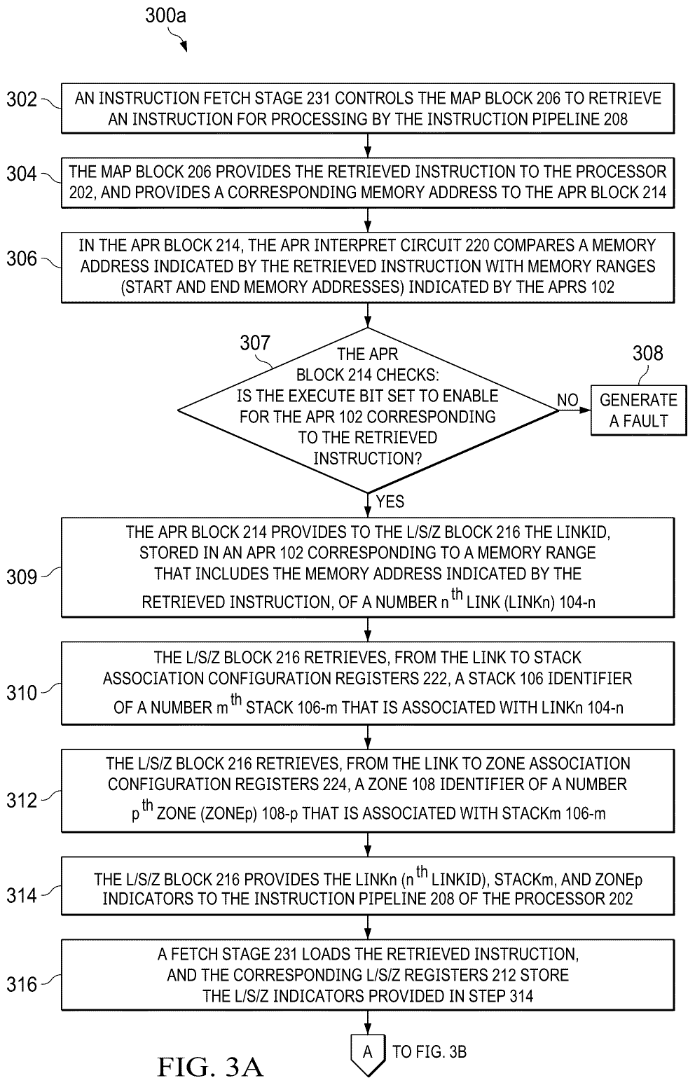

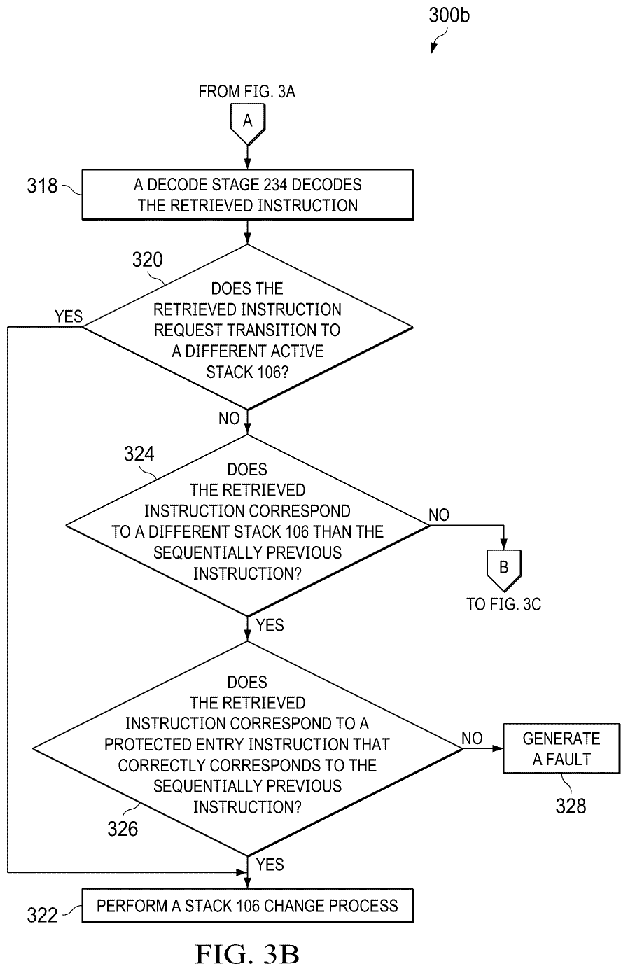

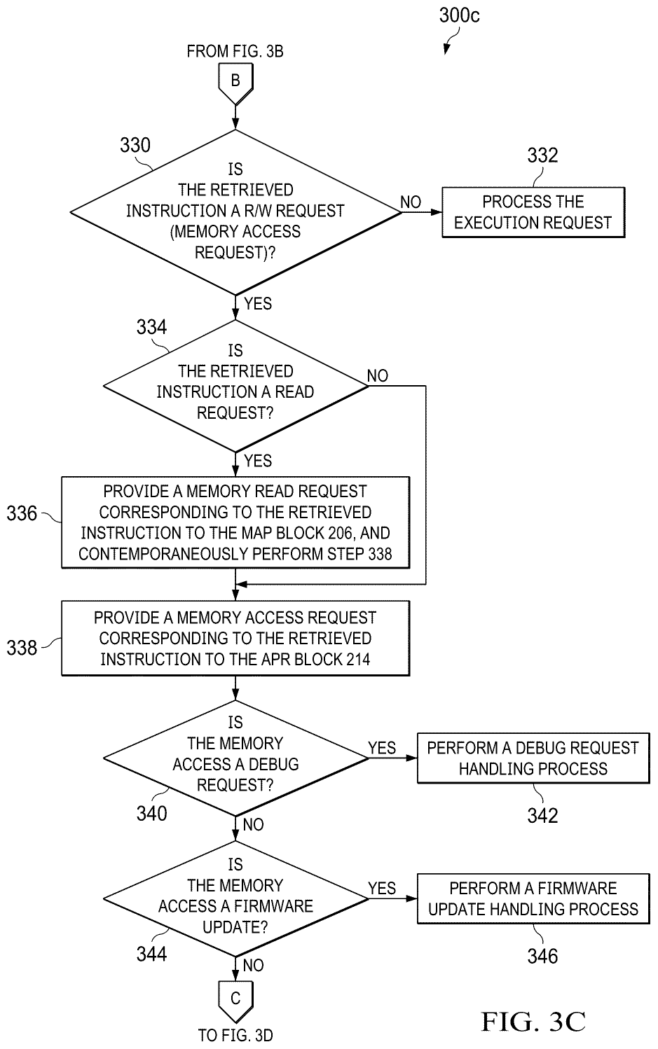

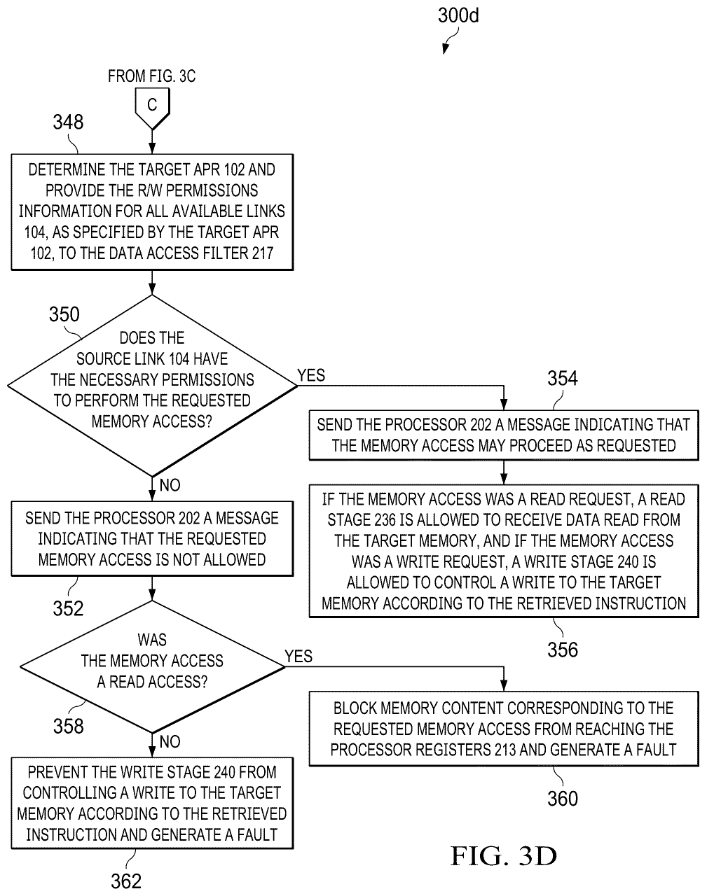

FIG. 3A is a first flow diagram of an example process 300 for processing an instruction using the processing system 200 of FIG. 2. FIG. 3A is continued in FIGS. 3B, 3C, and 3D. FIG. 3A shows a first portion 300a of the process 300, FIG. 3B shows a second portion 300b of the process 300, FIG. 3C shows a third portion 300c of the process 300, and FIG. 3D shows a fourth portion 300d of the process 300. A summary of the process 300 is provided prior to description of the process 300 in detail.

Initially, the instruction pipeline 208 performs an instruction fetch to retrieve an instruction from the MAP block 206. At the same time (such as in a same clock cycle) that the MAP block 206 provides an instruction to the instruction pipeline 208, the APR block 214 and the L/S/Z block 216 determine the source LINK 104, the STACK 106, and the ZONE 108 corresponding to the memory address specified by the instruction. The APR block 214 compares the memory address corresponding to the instruction fetch to memory ranges of the APRs 102 (in some examples, using the APR interpret circuit 220) to determine the LINKID of the source LINK 104.

The decoder 230 controls the LINK to STACK association configuration registers 222 to determine a STACK 106 identifier (or indicator) corresponding to the LINKID of the source LINK 104. In some examples, this corresponds to the decoder 230 determining which LINK to STACK association configuration register 222 corresponds to the determined LINKID of the source LINK 104, and accessing the determined LINK to STACK association configuration register 222 to retrieve the corresponding STACK 106 indicator. The decoder 230 controls the STACK to ZONE association configuration registers 224 to determine a ZONE 108 indicator corresponding to the determined STACK 106 indicator. In some examples, this corresponds to the decoder 230 determining which STACK to ZONE association configuration register 224 corresponds to the determined STACK 106 indicator, and accessing the determined STACK to ZONE association configuration register 224 to retrieve the corresponding ZONE 108 indicator.

The L/S/Z block 216 provides to the processor 202 the LINK 104, STACK 106, and ZONE 108 indicators corresponding to the determined source LINK 104, STACK 106, and ZONE 108. If the execution bit of the source APR 102 is set to an enable value, the retrieved instruction is added to the fetch stage 231 of the instruction pipeline 208, along with the source LINK 104, STACK 106, and ZONE 108 indicators determined by the APR block 214 and the L/S/Z block 216. Otherwise, a fault is signaled.

In response to a read or write instruction, in a later stage 210 (such as the read stage 236) the processor 202 provides the LINKID for the source LINK 104 and a memory access request corresponding to the R/W instruction to the data access filter 217. The data access filter 217 provides the target memory address to the APR block 214, which responsively provides the configuration settings for the target LINK 104 as stored by the target APR 102. The data access filter 217 checks the memory access function corresponding to the memory access request against the permissions specified in the target APR 102 for the source LINK 104. If the APR-stored permissions for the source LINK 104 allow the specified read or write, execution proceeds using the data or instruction retrieved from the addressed memory. Otherwise, a fault is signaled.

If the requested memory access is a read and the data access filter 217 determines that the source LINK 104 is not allowed to perform a read at the target memory address, the read is performed but the content of the retrieved data or instruction is blocked at a hardware level from use by the processor 202. Alternatively, in some examples, the read is blocked. If the requested memory access is a write and the data access filter 217 determines that the source LINK 104 is not allowed to perform a write at the target memory address, the write (the memory access) is blocked at a hardware level, for example, blocked from execution by the processor 202. Providing a write instruction to the data access filter 217 prior to the write stage 240 enables permissions to be determined and the write to be blocked before the corresponding write request is sent to the MAP block 206.

In some examples, a fault signaled according to insufficient access permissions as specified by a target APR 102 triggers an interrupt to initiate a fault handling process according to an interrupt service routine (ISR). In some examples, a fault signaled according to insufficient access permissions as specified by a target APR 102 corresponds to a code fault or an attempt to gain unauthorized access (an attack).

Accordingly, process integrity, such as FFI, is enforced automatically using stored permissions information and supporting hardware mechanisms. In some examples, this enables the device to avoid firewall setup, reconfiguration of an MPU, and/or certain other security policy-related changes as part of context switches. Other aspects of context switches, such as saving or reloading a process state, are handled according to user software or other (or related) hardware.

Handling of changes in the STACK 106 value between instructions in successive instruction pipeline 208 stages 210 is described with respect to FIGS. 8 to 13. Instructions corresponding to debug requests are handled responsive to ZONE 108 information, as described with respect to FIGS. 14 and 15. Instructions corresponding to firmware update requests are also handled responsive to ZONE 108 information, as described with respect to FIGS. 16 and 17.

Description of the process 300 in detail follows. Recall that individual stages 210, as illustrated, may correspond to multiple stages 210 in an implementation of the processor 202. For example, there may be multiple read stages 236, so that a first read stage 236 requests a read (a memory access) at a memory address of the MAP block 206 responsive to a first clock cycle, and a second read stage 236 receives the retrieved memory contents responsive to a second clock cycle sequentially following the first clock cycle. In step 302, an instruction fetch stage 231 controls the MAP block 206 to retrieve an instruction for processing by the instruction pipeline 208.

In step 304, the MAP block 206 provides the retrieved instruction to the processor 202, and provides a corresponding memory address to the APR block 214. In some examples, the instruction is a read, write, or execute instruction. In some examples, a read instruction or a write instruction uses buses external to the processor 202 to move information in or out of the processor 202, and an execute instruction controls activity internal to the processor 202. In some examples, an execute instruction may be an instruction to add values stored in two processor registers 213 together, or a branch instruction that controls the processor to fetch a next instruction from a memory location that is not sequentially next in the normal iterative order, or an instruction to compare a value stored in a register value to a number.

In step 306, in the APR block 214, the APR interpret circuit 220 compares the memory address provided by the MAP block 206 in step 304, which is the target memory address indicated by the fetch request corresponding to the retrieved instruction, with memory ranges (start and end memory addresses) indicated by the APRs 102. This determines a source APR 102 for the retrieved instruction. In some examples, a fault message may be provided by the APR block 214 to the processor 202 if zero APRs 102 or more than one APR 102 correspond(s) to the target memory address.

In step 307, the APR block 214 checks whether the execute bit, which determines whether data stored by the APR 102 is executable code or other (non-executable) data, is set to ENABLE. If the execute bit is set to/ENABLE (not ENABLE), then the retrieved instruction was fetched for use as an instruction in error, and in step 308, a fault is generated. In some examples, the APR block 214 provides a message to the processor 202 indicating the error, and the processor 202 generates the fault. If the execute bit is set to ENABLE, permission is granted to treat the retrieved instruction as executable code, and the process 300 proceeds at step 309.

In step 309, the APR block 214 provides to the L/S/Z block 216 the LINKID of a number nth LINK (LINKn) 104-n (the source LINK 104) that is stored in an APR 102 (the source APR 102) corresponding to a memory range that includes the target memory address. In the example described with respect to FIGS. 1A and 1B, n is between zero and fifteen.

In step 310, the L/S/Z block 216 retrieves, from the LINK to STACK association configuration registers 222, a STACK 106 identifier of a number mth STACK (STACKm) 106-m that is associated with LINKn 104-n. In the example described with respect to FIGS. 1A and 1B, m is between zero and seven. In step 312, the L/S/Z block 216 retrieves, from the STACK to ZONE association configuration registers 224, a ZONE 108 identifier of a number pth ZONE (ZONEp) 108-p that is associated with STACKm 106-m (and, accordingly, with LINKn 104-n). Accordingly, the LINK to STACK and STACK to ZONE association configuration registers 222 and 224 enable determination of the particular STACK 106 and ZONE 108 associated with the source LINK 104. In the example described with respect to FIGS. 1A and 1B, p is between zero and three. In step 314, the L/S/Z block 216 provides the LINKn (n^{th} LINKID), STACKm, and ZONEp indicators to the instruction pipeline 208 of the processor 202.

In step 316, a fetch stage 231 loads the retrieved instruction, and the corresponding L/S/Z registers 212 store the L/S/Z indicators provided in step 314. As the retrieved instruction propagates through the instruction pipeline 208, the corresponding L/S/Z indicators are provided to and stored by successive sets of the L/S/Z registers 212 corresponding to the stage 210 contemporaneously processing the retrieved instruction.

In some examples, a processor 202 can request fetch of multiple instructions (such as two instructions) in parallel that a compiler has determined can be executed in parallel. The multiple instructions are provided to both the processor 202 and the APR block 214. The multiple instructions are loaded into the fetch stage 231 and assembled into a grouped instruction (also called a packet) by a decode stage 234. If the decode stage 234 determines while assembling the grouped instruction that the multiple instructions do not correspond to the same source LINK 104 then a fault is signaled.

FIG. 3B is a second flow diagram continuing the example process 300 of FIG. 3A for processing an instruction using the processing system 200 of FIG. 2. As described above, FIG. 3B shows a second portion 300b of the process 300.

In step 318, a decode stage 234 decodes the retrieved instruction. Recall that the STACK 106 indicator and ZONE 108 indicator corresponding to the retrieved instruction are stored in the L/S/Z registers 212 corresponding to the decode stage 234 processing the retrieved instruction.

A STACK 106 (referring here to the functional stack referenced by the STACK 106) is also called a processor stack or a software stack (though it is implemented in hardware). A STACK 106 is a region of allocated memory used to store arguments, local variables and corresponding pointers, processor state data, and other data used during program execution. Data is added to a currently active STACK 106 at the memory location with the address held by a currently active functional stack pointer. Data is added to the STACK 106 by processes controlled according to respective LINKs 104 associated with the STACK 106. For example, a processing system 200 tracks a local variable, after the local variable is defined, by adding the local variable to the STACK 106 and incrementing the stack pointer so that a next data can be added to the active STACK 106.

The STACK 106 corresponding to APRs 102 from which instructions are being fetched, and which is actively being managed (or used) by the processor 202 to store and retrieve functional stack data, is referred to as the active STACK 106. In some examples, an active STACK 106 is a STACK 106 corresponding to processes or threads or a software context currently being processed by the processing system 200. Accordingly data is added to and read from the active STACK 106 and not other STACKs 106. In some examples, in a processing system 200 with a number M functional stack pointers corresponding to M STACKs 106, the processing system maintains a static copy of each of the M functional stack pointers, and maintains an active copy of the functional stack pointer corresponding to the currently active STACK 106.

The size of a STACK 106 (the functional stack referenced by the STACK 106) can grow or shrink during program execution based on the currently active functional stack pointer. If the STACK 106 grows beyond its pre-allocated space, corresponding to a stack overflow, then memory corruption can occur. An example way to prevent stack overflow by a STACK 106 is to design the memory region allocated to the STACK 106 to be contiguous with memory regions that are not accessible by any of the LINKs 104 associated with that STACK 106. Accordingly, if the STACK 106 expands beyond its allocated memory region and an instruction with a source LINK 104 associated with the STACK 106 attempts to access data in the overflow region, that instruction will not have access permission. The SSU 204 will deny the requested memory access and a fault will be generated.

The functional stack pointer with an active copy is the active functional stack pointer. Accordingly, an active STACK 106 corresponds to an active functional stack pointer, so that switching between STACKs 106 corresponds to switching between active functional stack pointers. Switching between STACKs 106 and between active functional stack pointers is further described with respect to FIG. 8 and subsequent figures.

In some examples, when the active STACK 106 transitions from a first STACK 106 to a second STACK 106, a hardware process copies the stack pointer corresponding to the first STACK 106 from the register storing the active functional stack pointer to the register storing the inactive version of the functional stack pointer for the first STACK 106. Also, the hardware process copies the functional stack pointer corresponding to the second STACK 106 from the register storing the inactive version of the functional stack pointer for the second STACK 106 to the register storing the active functional stack pointer.

In some examples, switching the active STACK 106 from a first STACK 106 to a second STACK 106 requires executing one or more particular instructions stored at particular memory locations to enter (enter execution according to) the second STACK 106. In some examples, the particular instructions trigger the hardware-based copying of functional stack pointer(s) described above. In some examples, switching the active STACK 106 from a first STACK 106 to a second STACK 106 also requires executing one or more particular instructions stored at particular memory locations to exit (exit execution according to) the first STACK 106. These exit and entry requirements provide a handshake process for STACK 106 transition that facilitates maintaining process isolation and security. Requiring execution of particular instructions stored at particular memory locations to switch STACKs 106 avoids accidental STACK 106 switching and deters unauthorized STACK 106 switching by forcing defined STACK 106 exit and entry points in respective memories corresponding to respective associated APRs 102.

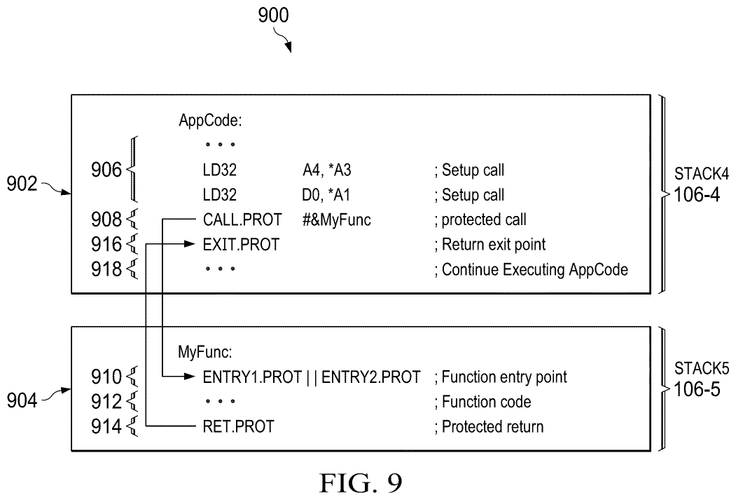

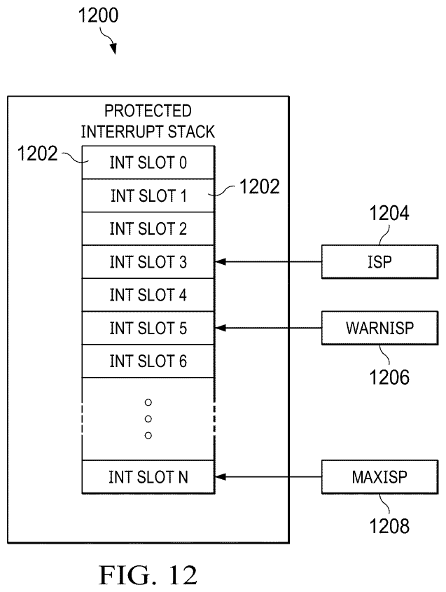

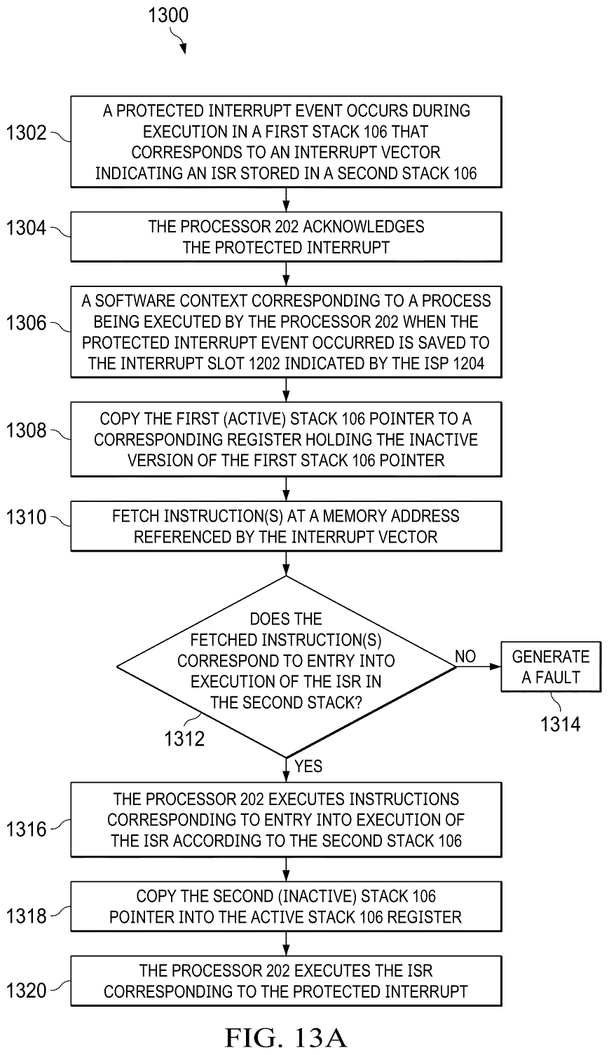

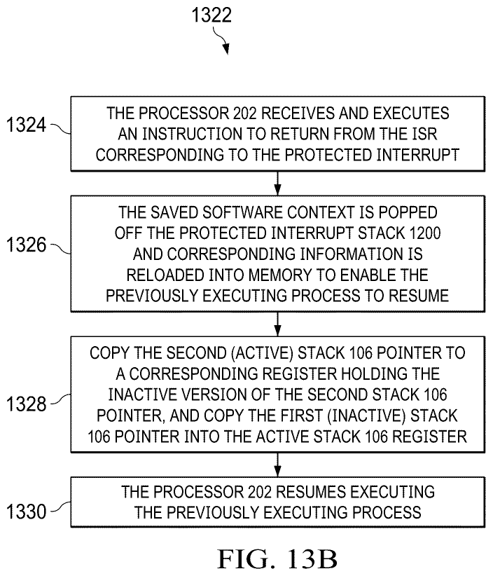

In step 320, a decode stage 234 determines whether the retrieved instruction requests transition to a different active STACK 106. As further described with respect to FIGS. 9 through 11B, this corresponds to a protected call instruction, protected branch instruction, or protected return instruction for exit from execution according to a current active STACK 106. Note that interrupts that initiate an ISR in a STACK 106 that is different (or may be different) than the current active STACK 106, operate outside of normal execution, and accordingly are further described with respect to FIGS. 12 and 13.

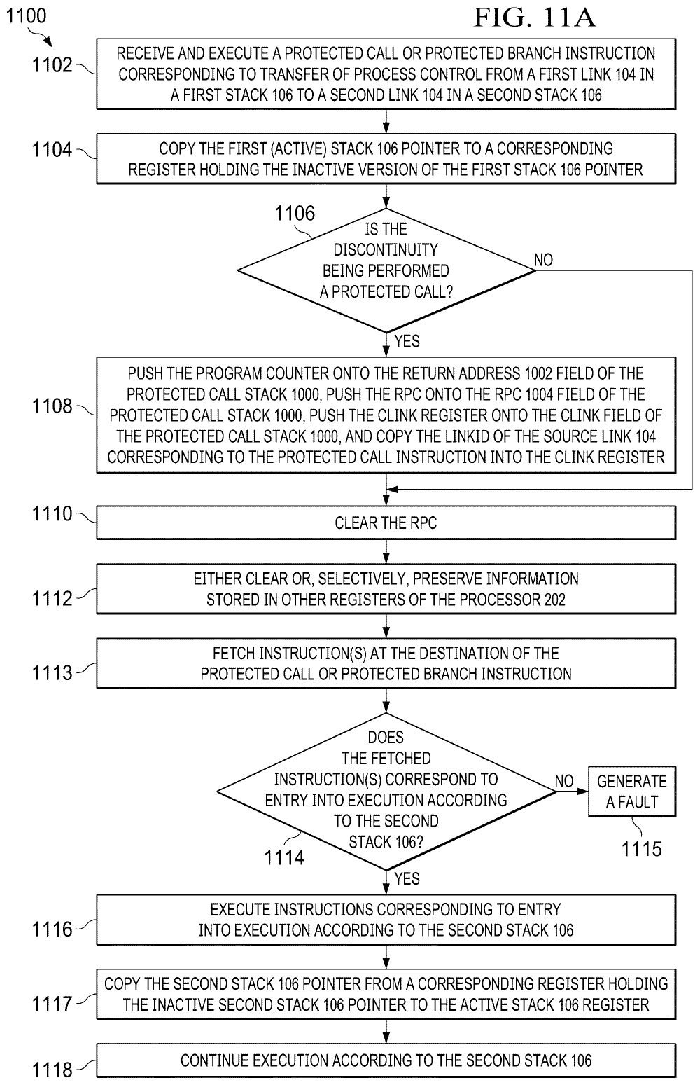

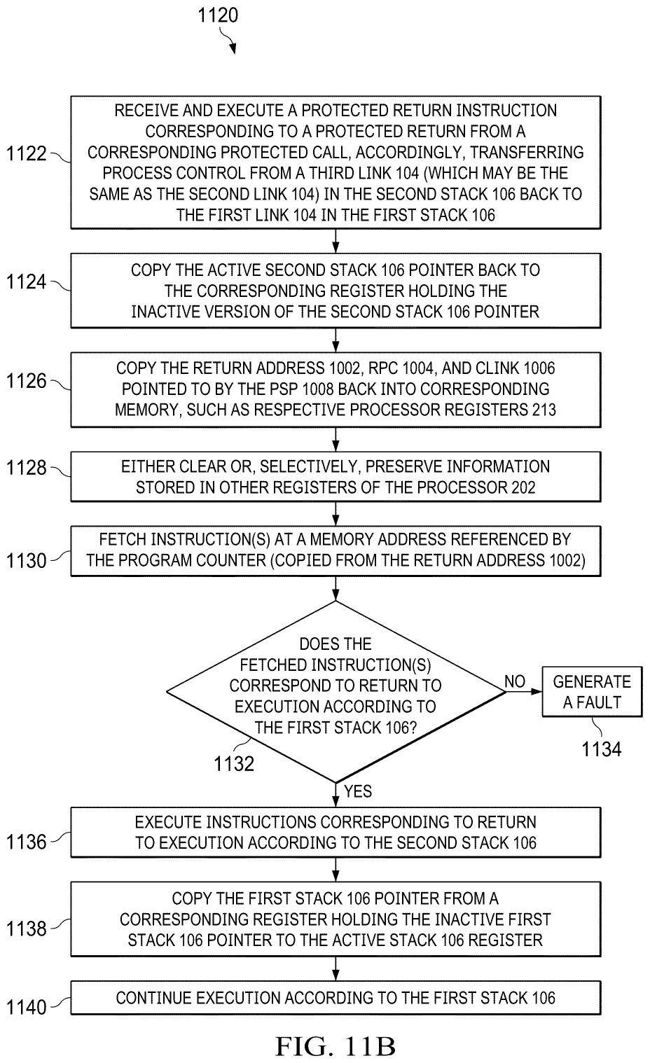

If in step 320 the decode stage 234 determines that the retrieved instruction requests that the active STACK 106 be changed, then in step 322 a corresponding portion of a STACK 106 change process 1100 or 1120 is performed. STACK 106 change processes 1100 and 1120 are described with respect to FIGS. 11A and 11B, respectively. Subject matter related to transitioning execution between STACKs 106 is described with respect to FIGS. 8 to 13. If the decode stage 234 determines that the retrieved instruction does not request to change the active STACK 106, the process 300 continues in step 324.

In step 324, a decode stage 234 determines whether the retrieved instruction corresponds to a different STACK 106 than the sequentially previous instruction. This corresponds to a comparison between L/S/Z registers 212 corresponding to the decode stage 234 and to a sequentially next stage 210 of the instruction pipeline 208 (such as another decode stage 234 or a read stage 236). If the STACK 106 identifiers are the same, then the process proceeds at step 330.

If the STACK 106 identifiers are different, then in step 326, a decode stage 234 determines whether the retrieved instruction corresponds to a protected entry or protected return instruction that correctly corresponds to the sequentially previous instruction (see FIGS. 8 to 13). If so, then in step 322, a corresponding portion of the STACK 106 change process 1100, 1120, or 1300 (FIG. 13) is performed. Otherwise, in step 328, a fault is generated.

FIG. 3C is a third flow diagram continuing the example process 300 of FIGS. 3A and 3B for processing an instruction using the processing system 200 of FIG. 2. As described above, FIG. 3C shows a third portion 300c of the process 300.

In step 330, a decode stage 234 determines whether the retrieved instruction is a R/W request. Otherwise it is an execute instruction. If the retrieved instruction is an execute instruction, then in step 332, the retrieved instruction is processed accordingly, including by the execute stage 238. If the retrieved instruction is a R/W request, then in step 334, the decode stage 234 determines whether the retrieved instruction is a read request. If the retrieved instruction is a read request, then in step 336, a read stage 236 controls a memory read request corresponding to the retrieved instruction to be provided to the MAP block 206, and contemporaneously performs step 338. If the retrieved instruction is a write request, the process 300 proceeds to step 338. In some examples, contemporaneously means simultaneously, during a same clock cycle, or in response to a same clock signal edge.

In step 338, the read stage 236 controls a memory access request corresponding to the retrieved instruction to be provided to the APR block 214. The provided memory access request is a read request for a read instruction and is a write request for a write instruction. In some examples, write requests are provided to the APR block 214 during a stage 210 prior to the write request being provided to the MAP block 214 to facilitate preventing unauthorized write requests from being performed prior to permissions being determined (for example, to avoid race conditions between writes and corresponding authorization). In some examples, initiating R/W authorization checks from a single stage 210 of the instruction pipeline 208 simplifies design.

In step 340, the APR block 214 determines whether the memory access is a debug request. If so, in step 342, a debug request handling process 1500 is performed. The debug request handling process 1500 is further described with respect to FIGS. 14 and 15. Otherwise, the process 300 continues with step 344.

In step 344, the non-volatile memory controller 232 determines whether the memory access corresponds to a Flash (firmware) update, accordingly, a Flash program command or erase command. If so, in step 346, a firmware update handling process 1700 is performed. Note that the firmware update controller 218, rather than the data access filter 217, controls access to Flash (or other firmware) memory and corresponding firmware update processes. The firmware update handling process 1700 is further described with respect to FIGS. 17 and 18. Otherwise, the process 300 continues with step 348. In some examples, a different type of non-volatile memory is used to store firmware, and/or different or additional memory controller(s) is used, and/or or the non-volatile memory controller 232 (or other controller) checks whether the memory access corresponds to different and/or additional firmware command(s).

FIG. 3D is a fourth flow diagram continuing the example process 300 of FIGS. 3A, 3B, and 3C for processing an instruction using the processing system 200 of FIG. 2. As described above, FIG. 3D shows a fourth portion 300d of the process 300.

In step 348, the APR block 214 determines the target APR 102 and provides the R/W permissions information for some or all of the available LINKs 104, as specified by the target APR 102, to the data access filter 217. In the examples illustrated in FIGS. 1A and 1B, the available LINKs 104 include LINKs 104 zero through fifteen. In step 350, the data access filter 217 compares the permissions granted to the source LINK 104 by the target APR 102 to the R/W permissions requested by the memory access request, and determines whether the source LINK 104 has the necessary permissions to perform the requested memory access.

If the source LINK 104 does not have sufficient permissions to complete the memory access request, then in step 352, the data access filter 217 sends the processor 202 a message indicating that the requested memory access is not allowed, and the process proceeds at step 358. If the source LINK 104 does have sufficient permissions to complete the memory access request, then in step 354, the data access filter 217 sends the processor 202 a message indicating that the memory access may proceed as requested and the process 300 continues at step 356. In step 356, if the memory access was a read request, a read stage 236 is allowed to receive data read from the target memory, and if the memory access was a write request, a write stage 240 is allowed to control a write to the target memory according to the retrieved instruction.

In step 358, check whether the memory access is a read access. If so, then in step 360 the processor 202, as a hardware process, blocks memory content corresponding to the requested memory access from reaching the processor registers 213 and a fault is generated. If not, then in step 362 the processor 202, as a hardware process, prevents the write stage 240 from controlling a write to the target memory according to the retrieved instruction and a fault is generated.

In some examples, blocking the requested memory content according to a disallowed read request includes processing the memory access to retrieve corresponding memory content such as data or instructions, and setting the retrieved content to a null value. Setting retrieved content to a null value may include setting all binary bits of the retrieved content to zero. In some examples, this enables the instruction pipeline 208 to continue processing the retrieved instruction as if the memory access was allowed. For example, blocked data that is zeroed may be written according to the retrieved instruction, or may be handled according to a fault handling process responsive to the fault message, such as to prevent operation on the zeroed data. Accordingly, setting retrieved content to a null value enables execution to proceed while maintaining confidentiality of the retrieved content with respect to an instruction, and corresponding execution state of the processor 202, that are not allowed to access that retrieved content. In some examples, fault handling responsive to the fault message uses corresponding (such as fault-specific) hardware and/or software.

In some examples, such as if the target APR 102 corresponds to a peripheral or other component that may have function changed by the performance of the read (such as a first in first out (FIFO) register or a component controlled by a FIFO register), a message may be sent by the data access filter 217 to the MAP block 206 to prevent the read. In some examples, if the target APR 102 of a read request corresponds to a peripheral, the read request is delayed (such as by a clock cycle) to facilitate interdicting the read request if it is unauthorized.

FIGS. 4, 5, and 6 provide example groupings of APRs 102 into LINKs 104 to illustrate some example approaches to grouping APRs 102 into LINKs 104. Other example approaches can be used to group APRs 102 into LINKs 104.

FIG. 4 is a first example grouping 400 of APRs 412-440 (e.g., APRs 102 of FIGS. 1A-1B) with LINKs 402-410 (e.g., LINKS of FIGS. 1A-1B) to determine which APRs will grant read and/or write permissions to those LINKs. APRs 412-440 are labeled according to the purpose or use of their respective address ranges, and LINKS 402-410 are labeled according to their respective process or process classes. Accordingly, this grouping 400 is determined according to a first set of respective processes or process classes that are described by the example titles of the illustrated LINKs 402-410. The grouping 400 describes which of the illustrated APRs 412-456 will have read and/or write permissions enabled for the LINK 402, 404, 406, 408, or 410 with which respective sets of those APRs 412-456 are grouped. Note that each LINK 402-410 in the grouping 400 is a source LINK 104 for at least some instructions stored by the MAP block 206, accordingly, each LINK 402-410 in the grouping 400 needs some read and/or write permission(s).

Each LINK 104 grouped with (provided read and/or write permissions by) a set of APRs 102 (such as according to the grouping 400) uses the functionality of the grouped APRs 102 to support the processes enabled by the APRs 102 associated with that LINK 104. APRs 102 are grouped with a LINK 104 because those are the APRs 102 designed to store permissions for read and/or write instructions fetched from memory associated with that LINK 104. Those permissions enable the LINK 104, when it is the source LINK 104, to control reads or writes as necessary to memory associated with the grouped APRs 102 to enable execution of the process(es) corresponding to that LINK 104. In some examples, additional or other organizing principles are used to determine which APRs 102 give memory access permissions to a LINK 104.

The grouping 400 includes a first LINK (LINK3 ) 402 corresponding to a real time control process, a second LINK (LINK4 ) 404 corresponding to a device initialization process, a third LINK (LINK5 ) 406 corresponding to a communications process, a fourth LINK (LINK6 ) 408 corresponding to a security and cryptology process (security/crypto), and a fifth link (LINK7 ) 410 corresponding to a safety supervisor process (such as a safety supervisor process for an automobile).

As noted above, APRs 412-456 are named according to the device and/or device function with which the corresponding APR 102 is associated. For example, blocks 412-420 represent APRs associated with memory ranges for storing: code 412, data 414, information for one or more pulse width modulators (PWMs) 416, information for one or more analog-to-digital converters (ADCs) 418, and information for a timer circuit controller 420. Functionality and data utilized or controlled by respective LINKs 402, 404, 406, 408, or 410 correspond to code/data/peripheral information stored in the memory ranges corresponding to the respective APRs 412-456 listed below.

LINK3 402, corresponding to the real time control process, requires access permissions to be granted by APRs 102 referencing memory ranges for storing: code 412, data 414, information for one or more PWMs 416, information for one or more ADCs 418, and information for a timer circuit controller 420. In some examples, an APR 102 defining a memory range storing code provides read and execute permissions for that memory range. In some examples, an APR 102 defining a memory range storing data provides read/write permissions, and not execute permissions, for that memory range.

LINK4 404, corresponding to the device initialization process, requires access permissions to be granted by APRs 102 referencing memory ranges for storing: code 430, data 432, configuration information for populating one or more general purpose input/output (GPIO) configuration registers (GPIO cfg regs) 434, configuration information for populating one or more clock configuration registers (clock cfg regs) 436, configuration information for a watchdog circuit 438, information for the timer circuit controller 420, and interrupt assignments 440.

LINK5 406, corresponding to the communications process, requires access permissions to be granted by APRs 102 referencing memory ranges for storing: code 422, data 424, information for one or more universal asynchronous receiver/transmitter (UART) controllers 426, information for one or more serial peripheral interface (SPI) controllers 428, and information for the timer circuit controller 420.

LINK6 408, corresponding to the security/crypto process, requires access permissions to be granted by APRs 102 referencing memory ranges for storing: code 442, data 444, information for one or more cryptographic circuits (crypto engines) 446, and information for a direct memory access (DMA) controller 448.

LINK7 410, corresponding to the safety supervisor process, requires access permissions to be granted by APRs 102 referencing memory ranges for storing: code 450, data 452, information for one or more controller area network (CAN) controllers 454, information for the PWMs 416, information for the ADCs 418, information for the timer circuit controller 420, information for the SPI controllers 428, information for the UART controllers 426, information for one or more cyclic redundancy check (CRC) circuits 456, configuration information for populating the GPIO configuration registers 436, configuration information for populating the clock configuration registers 438, and configuration information for the watchdog circuit 440.

FIG. 5 is a second example grouping 500 of APRs (e.g., APRs 102 of FIGS. 1A-1B) with LINKs (e.g., LINKs 104 of FIGS. 1A-1B) to determine which APRs 102 will grant read and/or write permissions to those LINKs 104. This grouping 500 is determined by a second set of respective contexts or context classes that are described by the example titles of the illustrated LINKs 502 and 504. The grouping 500 includes a first LINK (LINK5 ) 502 corresponding to a user communications context, and a second LINK (LINK6 ) 504 corresponding to a user control context. Blocks 506-530 respectively represent one or more APRs and are named according to the device(s) and/or device function with which the corresponding APR(s) is (or are) associated.

LINK5 502, corresponding to the user communications context, requires access permissions to be granted by APRs referencing memory ranges for storing: code 506, data 508, information for an SPI controller (SPIA, accordingly, an A controller) 510, information for two inter-integrated circuit controllers (12CA and 12CB, accordingly, A and B controllers) 512, information for two CAN controllers (CANA and CANB) 514, information for three UART controllers (UARTA, UARTB, and UARTC) 516, and information for an ADC (ADCA) 518.

LINK6 504, corresponding to the user control context, requires access permissions to be granted by APRs 102 referencing memory ranges for storing: code 520, data 522, information for six PWMs (PWM1, PWM2, PWM3, PWM4, PWM5, and PWM6) 524, information for two controllers for enhanced quadrature encoder pulse modules (EQEP1 and EQEP2) 526, information for three ADCs (ADCA, ADCB, and ADCC) 528, and information for controllers for four enhanced capture modules (ECAP1, ECAP2, ECAP3, and ECAP4) 530.

Different memory ranges associated with different APRs 102 may correspond to different memory types or different memory banks. In some examples, code 506 and/or code 520 are associated with memory ranges in non-volatile memory. In some examples, code stored in non-volatile memory associated with code 506 or code 520 is copied into volatile memory, such as RAM, during or after boot-up of the processing system 200 (or another processing system that includes an SSU such as the SSU 204 and similar SSU-related functionality). In some examples, data 508 and/or data 522 are associated with RAM or other volatile memory.

In some examples, different processes may require access to a same peripheral. Accordingly, note that the APR 102 corresponding to the ADCA block 518 gives memory access permissions to LINK5 502 and LINK6 504. 5

In some examples, different APRs 102 can reference a same memory range corresponding to code or data, at the possible expense of safety and/or security. In some examples, controlling a memory range to be writeable according to two different APRs 102 in two different LINKs 104 makes safety software-reliant. In an example, if two different LINKs 104 correspond to two different APRs 102 that reference a same memory range, then the two different LINKs 104 will separately rely on integrity of data stored in the writeable memory range, so that a write error by one of the LINKs 104 may cause a fault in execution according to the other LINK 104.

FIG. 6 is an example grouping 600 of APRs (e.g., APRs 102 of FIGS. 1A-1B) to associate the APRs 102 with respective LINKs (e.g., LINKs 104 of FIGS. 1A-1B). This grouping 600 can be described as a set of LINKs 104 (and accordingly, processes) that each govern a different type of peripheral, with a LINK 104 for a control process and related peripherals used to control and/or provide control parameters for the processes corresponding to the other LINKs 104. The APRs 102 associated with respective LINKs 104, and the memory content or peripherals stored in memory ranges referenced by respective APRs 102, are shaded to indicate such correspondence.

In some examples, memory regions associated with a same device and/or functionality are associated, via respective APRs 102, with a same LINK 104. In some examples, memory regions expected to need similar or the same memory access permissions are associated, via respective APRs 102, with a same LINK 104. In some examples, a different or additional organizing principle for associating APRs 102 with LINKs 104 is used. In some examples, association of an APR 102 with a LINK 104 corresponds to the APR 102 storing the LINKID of that LINK 104.

The grouping 600 includes a memory map 602 referencing multiple different memories corresponding to different memory types or peripherals. Specifically, the memory map 602 enables memory accesses to a Flash memory 604, a RAM 606, and a set of peripherals 608. The different memory types and peripherals respectively correspond to memory address ranges stored by a set of APRs 102.

Blocks 610-632 are memory regions associated by hardware and/or software (such as compiled software) with a device and/or device function. APRs 634-656 are respectively associated with those memory regions, so that each of the APRs 634-656 is associated with a device and/or a device function. Different sets of the APRs 634-656 are grouped together according to functionality into LINKs 658-664, so that APRs 634-656 associated with a same LINK 658-664 store a same LINKID.

The Flash memory 604 stores a control code 610 in a memory address range referenced by APR0 634, CAN code 612 in a memory address range referenced by APR1 636, an SPI code 614 in a memory address range referenced by APR2 638, and a UART code 616 in a memory address range referenced by APR3 640.

The RAM 606 stores a control data 618 in a memory address range referenced by APR4 642, a CAN data 620 in a memory address range referenced by APR5 644, an SPI data 622 in a memory address range referenced by APR6 646, and a UART data 624 in a memory address range referenced by APR7 648.

The peripherals 608 include PWMs, ADCs, and/or other peripherals (control peripherals) used in a peripheral control application 626, a CAN 628, an SPI 630, and a UART 632. Information used by the control application 626 (such as control information, input data, or output data) is referenced by APR8 650, information used by the CAN 628 is referenced by APR9 652, information used by the SPI 630 is referenced by APR 10 654, and information used by the UART 632 is referenced by APR11 656.

A first LINK (LINK3 ) 658, corresponding to a control application, is associated with APR0 634, corresponding to the control code 610, APR4 642, corresponding to the control data 618, and APR8 650, corresponding to the control peripherals 626. In some examples, a control process controls a motor or a digital power supply. A second LINK (LINK4 ) 660, corresponding to a CAN application 628, is associated with APR1 636, corresponding to the CAN code 612, APR5 644, corresponding to the CAN data 620, and APR9 652, corresponding to the CAN 628. A third LINK (LINK5 ) 662, corresponding to an SPI application 630, is associated with APR2 638, corresponding to the SPI code 614, APR6 646, corresponding to the SPI data 622, and APR10 654, corresponding to the SPI 630. A fourth LINK (LINK6 ) 664, corresponding to a UART application 664, is associated with APR3 640, corresponding to the UART code 616, APR7 648, corresponding to the UART data 624, and APR11 656, corresponding to the UART 632.

FIG. 7 is an example set of memories 700 of the MAP block 206 of FIG. 2. The set of memories 700 include a Flash memory 702, a RAM 704, and a ROM 706. The Flash memory 702 and the ROM 706 each store code and data. This is indicated using separate columns to support description herein, for example, to facilitate visualizing storage of different information corresponding to different utility (such as code or data) of the various LINKs (e.g., LINKs 104 of FIGS. 1A-1B).

Memory address ranges corresponding to LINKs 104 can be in a different order than an ordering of LINK 104 numbers, such as LINKIDs or LINK1, LINK2 , LINK3 , etc. Also, different APRs 102 corresponding to a single LINK 104 can reference non-contiguous memory address ranges in a memory of the set of memories 700, or reference memory address ranges in different memories of the set of memories 700. Expressed differently, multiple memory regions, within different memories and/or within a single memory, can belong to a same LINK 104. In some examples, the illustrated Flash memory 702 and RAM 704 columns do not correspond to physical or other separation of memory banks within respective memories.

The set of memories 700 store information corresponding to a first LINK (LINK0) 708 corresponding to a boot process, a second LINK (LINK1) 710 corresponding to boot loaders, a third LINK (LINK2 ) 712 corresponding to application initialization and update, a fourth LINK (LINK3 ) 714 corresponding to common libraries, a fifth LINK (LINK4 ) 716 corresponding to a main process or background process, a sixth LINK (LINK5 ) 718 corresponding to communications, a seventh LINK (LINK6 ) 720 corresponding to a control application, and an eighth LINK (LINK7 ) 722 corresponding to a process owned by a third party (3^{rd} party).

Memory address ranges of the Flash memory 702, the RAM 704, and the ROM 706 are contiguously allocated to respective sets of LINKs 104. These LINKs 104 are listed below in example memory address orders according to corresponding memories. In the examples, the LINKs 104 are listed in a memory address order from a lowest numbered address near the top of the page, such as, to a highest numbered address near the bottom of the page. For example, in hexadecimal, from (0×0 . . . 0) or other lowest numbered address to (0×f . . . f) or other highest numbered address.

In description of FIG. 7, a portion of the memory ranges associated (via one or more respective APRs 102) with a specified LINK 104 has a reference number with the format LINK [number] [letter]. This refers to the particular APR(s) 102 associated with the particular memory range being described (and associated with the specified LINK 104). The specified LINK 104 as a whole has the reference number format LINK [number].

Accordingly, the Flash memory 702 includes memory ranges corresponding to APRs 102 associated with, in memory address order, LINK2 712a (application initialization and update), LINK4 a 716 (main), LINK5 718a and 718b (communications), LINK3 714a (common libraries), LINK6 720a and 720b (control), and LINK7 722a (3rd party). The Flash memory 702 is configured (by hardware or software) to store code in memory regions corresponding to each of these LINKS 104. Memory regions associated (via respective APRs 102) with LINK5 718a are configured to store code, with LINK5 718b are configured to store data, with LINK6 720a are configured to store code, and with LINK6 720b are configured to store data.

The RAM 704 includes memory ranges corresponding to APRs 102 associated with, in memory address order, LINK5 718c, LINK0 708a, LINK1 710a, LINK2 712b, LINK4 716b, LINK3 714a, LINK5 718d, LINK6 720c, LINK4 716c and LINK5 718e in a shared memory space, LINK5 718f and LINK6 720d in a shared memory space, and LINK7 722b. The RAM 704 is configured to store data in memory regions associated (via respective APRs 102) with each of these LINK 104 segments, except the memory region associated with LINK5 718c is configured to store code. In some examples, different LINKs 104 that share a memory region can be secure against each other, but share selected data. This security and data sharing flexibility is enabled by user configuration of APRs 102 associated with respective LINKs 104. For example, an APR 102 can give multiple LINKs 104 specified R/W permissions.

The ROM 706 includes memory ranges corresponding to APRs 102 associated with, in memory address order, LINK0 708b and LINK1 710b. These APRs 102 are associated with memory ranges configured to store code.

The LINK5 718b code is copied from the Flash memory 702 to the RAM 704, such as during a boot process, and run from LINK5 718c in the RAM 704. In some examples, LINK5 718 or a different LINK 104 includes code to control the LINK5 718b code to be read from the Flash memory 702 and written to LINK5 718c in the RAM 704. Accordingly, LINK5 718b code is copied from a memory range in the Flash memory 702 associated with an APR 102 that has an executable bit set to FALSE, to a memory range in the RAM memory 704 associated with an APR 102 (corresponding to LINK5 718c) that has an executable bit set to TRUE. As described above, in some examples, APRs 102 defining memory ranges designated for data storage have respective executable bits set to FALSE to avoid safety and/or security breaches resulting from unintended or hostile execution of data not intended to function as executable instructions.

In some examples, a LINK 104 that performs this copy action has read permissions in the region of Flash memory 702 where the LINK5 718b code is stored, and write permissions in the region of RAM 704 where the LINK5 718c code is written. Accordingly, the copy action corresponds to permissions for two separate memory ranges. In some examples, the copy action corresponds to two (or more) separate APRs 102, one having read permissions in the appropriate region of Flash memory 702, and the other having write permissions in the appropriate region of RAM 704.

As described above, a single LINK 104 is associated with a STACK 106, or multiple LINKs 104 may be associated with the same STACK 106. For example, LINK4 716 and LINK6 720 can share a same STACK 106 if certain conditions are met. In particular, first, if there is no secrecy requirement between designers of LINK4 716 contents (such as code and data) and LINK6 720 contents. And second, if system design does not require a level of process integrity guaranty between processes corresponding to LINK4 716 and LINK6 718 corresponding to STACK 106 separation. In some examples, LINKs 104 sharing a STACK 106 depends on additional, fewer, or different conditions.

### III. STACK Switching

FIG. 8 is a table 800 of example instruction names and corresponding functionality descriptions for transitioning from execution by the processing system 200 of FIG. 2 according to a first STACK 106, to execution according to a second, different STACK 106. The processing system 200 uses these instructions to move execution across a STACK 106 boundary. The boundary of a STACK 106 refers to the set of memory ranges defined by the APRs 102 that are associated with the LINKs 104 that are associated with the STACK 106. Moving execution across the STACK 106 boundary refers to moving execution from a first memory range defined by a first APR 102 that is associated with a first LINK 104 that is associated with a first STACK 106, to a second memory range defined by a second APR 102 that is associated with a second LINK 104 that is associated with a second STACK 106.

In some examples, changing the active functional stack is allowed, and in some examples only allowed, when a discontinuity is being performed. Discontinuities include calls, returns, branches, and interrupts.

The table 800 includes a first column 802 containing instructions, and a second column 804 containing descriptions of functionality of the instructions. The first column 804 includes instructions for switching STACKs 106 with example names CALL.PROT, LB.PROT, ENTRY1.PROT, ENTRY2.PROT, EXIT.PROT, RET.PROT, ISR1.PROT, ISR2.PROT, and RET1.RTINT. CALL.PROT is a protected call. LB.PROT is a protected branch. ENTRY1.PROT and ENTRY2.PROT are first and second protected entry point instructions for a protected call or a protected branch. EXIT.PROT is a protected return exit point. RET.PROT is a protected return from a corresponding previous call. ISR1.PROT and ISR2.PROT are first and second protected ISR entry point instructions following an interrupt. RET1.RTINT is a return from a corresponding real time interrupt. A real time interrupt, also referred to as a protected interrupt, is an interrupt that triggers execution of an ISR in a STACK 106 different from the STACK 106 in which process flow is proceeding prior to the protected interrupt event.

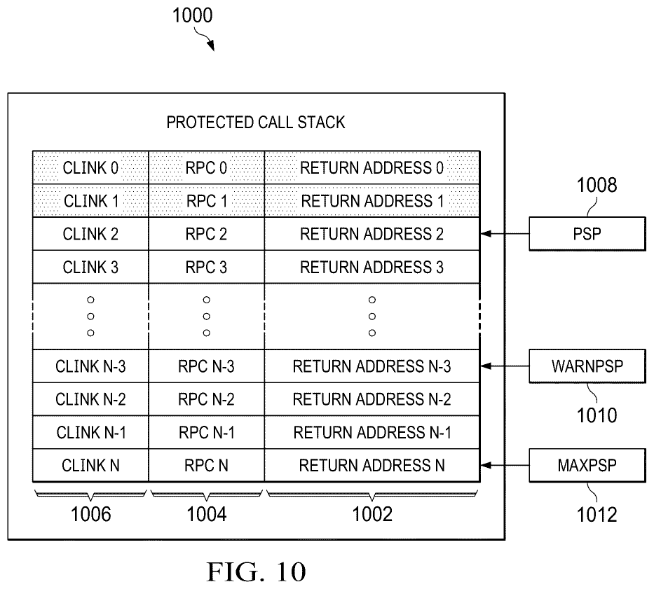

A program counter is a register (or other memory) in the processor 202 that stores a memory address of a next instruction to be executed. In some examples, executing a call instruction controls a copy of a program counter to be pushed onto a protected call stack 1000 (FIG. 10), and subsequently controls the program counter to be changed to a specified memory location. In some examples, the specified memory location corresponds to a different process, corresponding to a different LINK 104 that is in the same STACK 106 or a different STACK 106 as the previously executing process. In some examples, additional information about the process (or software context) being executed prior to the call instruction is also saved. Calls and the protected call stack 1000 are further described with respect to FIGS. 9 and 10.

A CALL.PROT instruction is a type of call instruction that may be used to transfer process control from a first STACK 106 to a second STACK 106. A call instruction is often followed (eventually) by a return instruction. Executing a return instruction controls the program counter value at the top of the protected call stack 1000 to be popped off the protected call stack 1000 as the new program counter. The popped program counter returns process control to a point following the corresponding previous call instruction.

As described above, an EXIT.PROT instruction and a RET.PROT instruction are used to perform a return following a call. An EXIT.PROT instruction is required, following a CALL.PROT instruction (and, in some examples, following intervening execution according to a subroutine beginning at the called memory location), as a condition for exiting process control by the second STACK 106 to return process control to the first STACK 106. A RET.PROT instruction is required as a condition for reentering process control by the first STACK 106. In some examples, the RET.PROT is required to be the first instruction executed after EXIT.PROT is executed. Accordingly, the EXIT.PROT and RET.PROT instructions enable a two-way handshake (instruction handshake) across a STACK 106 boundary to enable a safe and secure return following a cross-STACK 106 call. In some examples, checks for handshake instructions, such as CALL.PROT, LB.PROT, ENTRY1.PROT, ENTRY2.PROT, EXIT.PROT, or RET.PROT, are performed as a hardware process.

Executing a branch instruction permanently transfers process control to a specified memory location, so that a program counter and intra-STACK 106 call history preceding the branch are discarded. Accordingly, return is not performed responsive to a branch. In some examples, a branch instruction is similar to a call instruction, but without use of the protected call stack 1000 to provide for return to process control at a memory location following the branch location.

ENTRY1.PROT and ENTRY2.PROT must be executed in parallel to enable entry into execution of a STACK 106 responsive to a call instruction or a branch instruction. A memory location storing ENTRY1.PROT and ENTRY2.PROT corresponds to an entry point for a corresponding STACK 106. Accordingly, requiring that entering execution according to a STACK 106 begin with ENTRY1.PROT and ENTRY2.PROT corresponds to requiring that such execution begin at a designated memory location. This enforces execution according to designed functionality, supporting both safety and security.

In some examples, ENTRY1.PROT and ENTRY2.PROT are required to be the next instructions executed after CALL.PROT or LB.PROT is executed. Accordingly, the ENTRY1.PROT and ENTRY2.PROT instructions enable a two-way handshake (instruction handshake) across a STACK 106 boundary to enable a safe and secure transfer of process control from a first STACK 106 to a second STACK 106 responsive to execution of CALL.PROT or LB.PROT. In some examples, if execution according to the second STACK 106 begins with instructions other than parallel execution of ENTRY1.PROT and ENTRY2.PROT, a fault is generated by a hardware process. In some examples, this hardware process occurs in a pipeline stage 210 such as a decode stage 234.

In some examples, an additional instruction, PRESERVE (not shown), can be used in parallel with the ENTRY1.PROT and ENTRY2.PROT instructions to preserve, or store for later use, specified local variables or other information from the STACK 106 being exited.

In an example, code corresponding to a particular LINK 104 in a first STACK 106 checks whether the value of a parameter is valid. An attacker may attempt to jump directly from a second STACK 106 to a location within the first STACK 106 that is not the designated entry point. Accordingly, the attacker may attempt to jump to a memory range defined by an APR 102 within the second STACK 106 that does not store ENTRY1.PROT and ENTRY2.PROT. If the attacker is able to do this, they may be able to avoid the parameter value validity check.

An example instruction pipeline 208 is 128 bits wide. In some examples, instructions are sixteen, thirty-two, or forty-eight bits wide. In some examples, ENTRY1.PROT and ENTRY2.PROT are each forty-eight bits wide. ENTRY1.PROT and ENTRY2.PROT are executed in parallel to fill up as much of the execution width as possible. ENTRY1.PROT and ENTRY2.PROT are designed so that they cannot be imitated, such as bitwise replicated, by other instructions or instructions plus arbitrary data. In some examples, ENTRY1.PROT and ENTRY2.PROT are designed so that this is true whether other instructions and/or data are aligned with entry to the instruction pipeline 208, or offset (shifted) by one or more bits.

The parallel execution requirement and the anti-imitation design of ENTRY1.PROT and ENTRY2.PROT prevent an attacker from finding a code pattern to fool the processor 202 into allowing entry into a STACK 106 at a memory location other than at a designed entry point. Accordingly, entry into a STACK 106 is limited to a LINK 104 and associated APR(s) 102 corresponding to a memory location storing ENTRY1.PROT and ENTRY2.PROT.

An interrupt is a prioritized request for execution of an ISR. Executing an interrupt controls a copy of the program counter to be pushed onto a protected interrupt stack 1200 (FIG. 12), a processor 202 context to be saved, and process control to be transferred to a specified memory location corresponding to the ISR. On return from the ISR, the program counter is popped off the protected interrupt stack 1200, the software context is reloaded, and process control returns to the same memory location as prior to the interrupt. Interrupts and the protected interrupt stack 1200 are further described with respect to FIG. 12.

In some examples, ISR1.PROT and ISR2.PROT are required to be executed in parallel as the first instructions executed in an ISR. An interrupt vector is an address that informs an interrupt handler where to find a corresponding ISR. If during normal execution according to a first STACK 106 an interrupt occurs, such as responsive to a hardware trigger, and a corresponding ISR is located in a second STACK 106, then the interrupt vector points to a memory location in the second STACK 106 where ISR1.PROT and ISR2.PROT are stored.

In some examples, each interrupt is assigned an identifying number, and each possible interrupt-identifying number is associated with a specific interrupt vector. Accordingly, similar to ENTRY1.PROT and ENTRY2.PROT, the memory location where ISR1.PROT and ISR2.PROT are stored provides an entry point into execution of an ISR according to the corresponding (second) STACK 106. In some examples, if ISR execution begins with instructions other than parallel execution of ISR1.PROT and ISR2.PROT, a fault is generated by a hardware process. In some examples, this hardware process occurs in a pipeline stage 210 such as a decode stage 234. In some examples, checks for instructions required to enter and return from a cross-STACK interrupt, such as ISR1.PROT, ISR2.PROT, and RET1.RTINT, are performed as a hardware process.

FIG. 9 is an example set of instructions 900 that includes a protected call instruction across a STACK 106 boundary and corresponding return instructions for execution by the processing system of FIG. 2. The set of instructions 900 includes a first process 902 in a first STACK 106, STACK4 106-4, and a second process 904 in a second STACK 106, STACK5 106-5. The instructions shown in STACK4 106-4 correspond to a first process (AppCode) corresponding to a first LINK 104, and the instructions shown in STACK5 106-5 correspond to a second process (MyFunc) corresponding to a second LINK 104.

In order of execution, memory load instructions 906 are executed to prepare for the call instruction. CALL.PROT 908 is executed to transfer control to a memory location in STACK5 106-5 that is specified by the #&MyFunc operand and that corresponds to a beginning of the MyFunc process. The memory location corresponding to #&MyFunc stores ENTRY1.PROT and ENTRY2.PROT 910, which are executed in parallel, as indicated by the ∥ operator. This enables entry into execution according to STACK5 106-5.

After the remaining instructions 912 in the MyFunc process are executed (for example, the MyFunc subroutine is completed), RET.PROT 914 in STACK5 106-5 is executed to return process control to AppCode. EXIT.PROT 916 is executed to complete the instruction handshake, receive process control in AppCode, and resume execution according to STACK4 106-4. Subsequently, further instructions 918 in AppCode are executed.

FIG. 10 is a table illustrating an example protected call stack 1000 supporting operation of the processing system of FIG. 2. In some examples, a call across STACK 106 boundaries, accordingly using CALL.PROT (or similar instruction), is referred to as a protected call. Accordingly, the protected call stack 1000 is used responsive to such protected calls. The protected call stack 1000 is a dedicated hardware stack that is protected against modification by software, other than by the root of trust LINK 104 (such as LINK2 104 according to the example illustrated by FIG. 1B). The protected call stack 1000 is shared across ZONEs 108.

The protected call stack 1000 includes a return address 1002 field, a return program counter (RPC) 1004 field, and a call link (CLINK) 1006 field. A protected stack pointer (PSP) 1008 is a register that stores a memory location corresponding to a next row of the protected call stack 1000. The return address 1002, RPC 1004, and CLINK 1006 are numbered from a first row of the protected call stack 1000 (row zero) to an (N+1) th row of the protected call stack 1000 (row N). Accordingly, the protected call stack 1000 includes fields that can store return address 0 (1002) through return address N (1002), RPC 0 (1004) through RPC N (1004), and CLINK 0 (1006) through CLINK N (1006).

A CLINK register is a processor register 213 or a bit field within a processor register 213. In some examples, the processor register 213 is protected against modification by software. As part of a protected call, the LINKID stored by an APR 102 associated with the memory location from which the protected call instruction was executed is written to the CLINK register. Accordingly, the CLINK register stores the LINKID of the LINK 104 associated with that APR 102, so that the STACK 106 to which execution is transferred after a protected call knows by which process it was called. In software, CLINK is used to enable a function to check which LINK 104 called that function. In hardware, CLINK enables protective inheritance.

In some examples, as further described below, the fields tracked by a PSP 1008 correspond to instruction-wise progress and history of execution. By way of comparison and as described above, a STACK 106 pointer corresponds to a functional stack that tracks data used by processes associated with the STACK 106.

A return address 1002 corresponds to a program counter to which a process returns after a RET.PROT following a corresponding protected call (using CALL.PROT) across a STACK 106 boundary. Accordingly, the return address 1002 should point to an EXIT.PROT instruction to complete the two-way return handshake described with respect to FIGS. 8 and 9.

When a call is performed that does not cross a STACK 106 boundary, the program counter corresponding to the calling process is copied to an RPC register to track where process control should go back to after a return is performed corresponding to the call. When an intra-STACK 106 call is performed and the RPC register is not empty, the RPC register is copied onto the functional stack indexed by the active STACK 106 and the program counter corresponding to the calling process is copied to the RPC register. The functional stack corresponding to the active STACK 106 is preserved in response to a protected call.

When a call crossing STACK 106 boundaries is performed, the current program counter is pushed onto the protected call stack as the return address 1002, the current RPC 1004 is pushed onto the protected call stack 1000, a value in the CLINK register is pushed onto the protected call stack 1000 as CLINK 1006, and the LINKID of the source LINK 104 corresponding to the protected call instruction is copied into the CLINK register. If execution of a process corresponding to the return address 1002 was proceeding in a subroutine prior to the cross-STACK 106 call, retaining the corresponding RPC 1004 enables execution of the subroutine to pop to a routine that called the subroutine as would be expected if execution were solely intra-STACK 106.

In an example of protective inheritance, a control function corresponding to a first STACK 106 makes a protected call to a utility function corresponding to a second STACK 106 to apply that utility function to a memory location corresponding to a target APR 102 associated with a third STACK 106 (that may be the same as or different from the first STACK 106). An example of such a utility function is a memory copying function. The target APR 102 storing (enabled) R/W permissions for the utility function could give rise to a safety and/or security violation, because it is the control function, rather than the utility function, that directs how the utility function is applied.

In some examples, each APR 102 stores an APILINK value, so that if an APR 102 is a target APR 102 of an instruction being executed according to the instruction pipeline 208, the APILINK value is compared to the LINKID for the source LINK 104. If the APILINK and source LINK 104 LINKID are the same, then the LINKID stored by the CLINK register is substituted for the APILINK LINKID. Accordingly, the CLINK LINKID is treated as the LINKID of the source LINK 104, and the data access filter 217 checks R/W permissions according to the CLINK LINKID. This enables R/W permissions to be determined for a control function that uses a utility function to access a target memory. In some examples, if an APILINK source LINK 104 does not have permissions for a requested memory access, then a fault is generated and/or a return from the protected call (cross-STACK 106 call) is performed.

In some examples, the protected call stack 1000 has a finite number of rows. A warning PSP (WARNPSP) 1010 is a register that stores a memory location corresponding to a row of the protected call stack 1000 that is near a last (N+1) th row of the protected call stack 1000 (row N). A warning message is provided, such as to a monitoring process or to a user, if the PSP 1008 reaches the warning PSP 1010. In some examples, the warning PSP 1010 is a user defined level (or row). The warning message assists in avoiding reaching a fault state corresponding to attempting to exceed a maximum size of the protected call stack 1000, accordingly, a maximum depth of nested protected calls.

A maximum PSP (MAXPSP) 1012 is a register that stores a memory location corresponding to a last row of the protected call stack 1000. There is no higher numbered row of the protected call stack 1000 for the PSP 1008 to be incremented to after the PSP 1008 reaches the maximum PSP 1012. In some examples, the maximum PSP 1012 is a fixedly coded level (such as in non-volatile memory), or a hardware encoded level, at which the processor 202 enters a fault state if a protected call is attempted. In some examples, a protected call attempted when the PSP 1008 is at the maximum PSP 1012 causes the processor 202 to generate a non-maskable interrupt to enter the fault state.

FIG. 11A is a flow diagram of an example process 1100 for transferring process control from a first STACK 106 to a second STACK 106 according to a protected call instruction or a protected branch instruction executed by the processing system 200 of FIG. 2. In some examples, steps of the process 1100 are performed in the processor 202.

In step 1102, receive and execute a protected call or a protected branch instruction, such as a CALL.PROT instruction or LB.PROT instruction. The protected call or protected branch instruction controls transfer of process control from a first LINK 104 in the first STACK 106 to a second LINK 104 in the second STACK 106. In step 1104, copy the first (active) STACK 106 pointer to a corresponding register holding the inactive version of the first STACK 106 pointer.

In step 1106, determine whether the discontinuity being performed is a protected call, for example, executed according to a CALL.PROT instruction. If so, then in step 1108, push the program counter onto the return address 1002 field of the protected call stack 1000, push the RPC onto the RPC 1004 field of the protected call stack 1000, push the CLINK register value onto the CLINK field of the protected call stack 1000, and copy the LINKID of the source LINK 104 corresponding to the protected call instruction into the CLINK register. Otherwise, if the discontinuity being performed is a protected branch instruction (such as LB.PROT), then skip from step 1106 to step 1110 (skip over step 1108).

In some examples, additional state information of the software context corresponding to the first STACK 106 can be stored. In step 1110, clear the RPC. In step 1112, either clear or, selectively, preserve information stored in other processor registers 213. Accordingly, information stored in the processor registers 213 can be selectively preserved according to a PRESERVE instruction executed in parallel with the ENTRY1.PROT and ENTRY2.PROT instructions.

In step 1113, fetch the instruction(s) at the destination of the protected call or protected branch instruction. In step 1114, determine whether the fetched instruction(s) correspond to entry into execution according to the second STACK 106, such as ENTRY1.PROT and ENTRY2.PROT instructions to be executed in parallel. If the fetched instruction(s) does not correspond to entry into execution according to the second STACK 106, then in step 1115, generate a fault. If the fetched instruction(s) does correspond to entry into execution according to the second STACK 106, then in step 1116, execute the instruction(s) to enter into execution according to the second STACK 106.

In step 1117, copy the second STACK 106 pointer from a corresponding register holding the inactive second STACK 106 pointer to the active STACK 106 register. Step 1117 transfers execution control from the first STACK 106 to the second STACK 106. In step 1118, continue execution according to the second STACK 106.

FIG. 11B is a flow diagram of an example process 1120 for transferring process control from a second STACK 106 to a first STACK 106 according to a return instruction following a protected call instruction according to FIG. 11A. In some examples, steps of the process 1120 are performed in the processor 202.

In step 1122, receive and execute a protected return instruction, such as an EXIT.PROT instruction, corresponding to a protected return from a corresponding protected call. The protected return instruction controls transfer of process control from a third LINK 104 (which may be the same as the second LINK 104 described according to FIG. 11A) in the second STACK 106 back to the first LINK 104 in the first STACK 106. In step 1124, copy the active second STACK 106 pointer back to the corresponding register holding the inactive version of the second STACK 106 pointer.

In step 1126, copy the return address 1002, RPC 1004, and CLINK 1006 pointed to by the PSP 1008 back into corresponding memory, such as respective processor registers 213. Accordingly, pop the information from the top of the protected call stack 1000 back into memory so that execution according to the first LINK 104 in the first STACK 106 can resume following the point where a corresponding protected call was performed.

In step 1128, either clear or, selectively, preserve information stored in other processor registers 213. Accordingly, selectively preserve information stored in the processor registers 213 according to a PRESERVE instruction executed in parallel with the ENTRY1.PROT and ENTRY2.PROT instructions.

In step 1130, fetch instruction(s) at a memory address referenced by the program counter, which was copied back from the return address 1002 in step 1126. In step 1132, determine whether the fetched instruction(s) corresponds to return to execution according to the first STACK 106. In some examples, a RET.PROT instruction completes a cross-STACK 106 return handshake with the EXIT.PROT instruction executed according to step 1122. In step 1134, if the fetched instruction(s) does not complete the cross-STACK 106 return handshake, generate a fault.

In step 1136, if the fetched instruction(s) does complete the cross-STACK 106 return handshake, execute the fetched instruction(s) to return to execution according to the first STACK 106. In step 1138, copy the first STACK 106 pointer from a corresponding register holding the inactive first STACK 106 pointer to the active STACK 106 register. Step 1138 transfers execution control back from the second STACK 106 to the first STACK 106. In step 1140, continue execution according to the first STACK 106.

FIG. 12 is a table illustrating an example protected interrupt stack 1200 supporting operation of the processing system 200 of FIG. 2. As described above, in some examples, an interrupt triggering execution of an ISR in a different STACK 106 is referred to as a protected interrupt. Accordingly, the protected interrupt stack 1200 is used responsive to such protected interrupts. The protected interrupt stack 1200 is protected against modification by software, other than by the root of trust LINK 104. The protected interrupt stack 1200 is shared across ZONEs 108.

In some examples, a protected interrupt is also called a high-priority interrupt or a real-time interrupt. In some examples, the protected interrupt stack 1200 is called a real-time interrupt stack 1200. In some examples, a protected interrupt can be taken at any time.

The protected interrupt stack 1200 includes a number (N+1) interrupt slots (int slot 0through int slot 1) 1202 for storage of software context information. In some examples, a processing system 200 includes multiple processors 202, and each processor 202 has an address so that the processing system 200 can track which processor 202 executes respective processes according to respective LINKs 104). Interrupt slots 1202 store information corresponding to a process being executed by a particular processor 202 prior to an interrupt. In some examples, such information includes a processor 202 address, data, registers used for computation, status registers, a return address, and an RPC. The return address corresponds to the program counter prior to the interrupt. An RPC is described above with respect to FIG. 10.

An interrupt stack pointer (ISP) 1204 is similar in some respects to a PSP 1008. The ISP 1204 is a register that stores a memory location corresponding to a next row of the protected interrupt stack 1200.

A warning ISP (WARNISP) 1206 is similar in some respects to a warning PSP 1010. A warning ISP 1206 is a register that stores a memory location corresponding to an interrupt slot 1202 that is near a last (N+1) th interrupt slot 1202 (int slot N). A warning message is provided, such as to a monitoring process or to a user, if the ISP 1204 reaches the warning PSP 1206. In some examples, the warning ISP 1010 is a user defined level (or row). The warning message assists in avoiding reaching a fault state corresponding to attempting to exceed a maximum size of the protected interrupt stack 1200, accordingly, a maximum depth of nested interrupts.

A maximum ISP (MAXISP) 1208 is a register that stores a memory location corresponding to a last row of the protected interrupt stack 1200. There is no higher numbered row of the protected interrupt stack 1200 for the ISP 1204 to be incremented to after the ISP 1204 reaches the maximum ISP 1208. In some examples, the maximum ISP 1208 is a fixedly coded level (such as in non-volatile memory), or a hardware encoded level, at which the processor 202 enters a fault state if a protected interrupt is attempted. In some examples, a protected interrupt attempted when the ISP 1204 is at the maximum ISP 1208 causes the processor 202 to generate a non-maskable interrupt to enter the fault state.

FIG. 13A is a flow diagram of an example process 1300 for transferring process control across a STACK 106 boundary according to a protected interrupt and performing an ISR. In some examples, transfer of execution control to an ISR corresponding to a protected interrupt is similar to transfer of execution control to an ISR responsive to a high-priority interrupt in a processing system that does not include permissions association trees 101, except for steps used to address cross-STACK 106 control transfer. In some examples, steps of the process 1300 are performed in the processor 202.

In step 1302, a protected interrupt event occurs during execution in a first STACK 106 that corresponds to an interrupt vector indicating an ISR stored in memory associated (via corresponding APR(s) 102 and LINK(s) 104) with a second STACK 106. In step 1304, the processor 202 acknowledges the protected interrupt. In step 1306, a software context corresponding to a process being executed by the processor 202 when the protected interrupt event occurred is saved to the interrupt slot 1202 indicated by the ISP 1204. In step 1308, the first (active) STACK 106 pointer is copied into the corresponding register holding the inactive version of the first STACK 106 pointer.

In step 1310, fetch instruction(s) at a memory addressed referenced by the interrupt vector. In step 1312, determine whether the fetched instruction(s) correspond to entry into execution of the ISR in the second STACK 106. In some examples, step 1312 corresponds to a check whether the fetched instructions are ISR1.PROT and/or ISR2.PROT. In step 1314, if the fetched instruction(s) do not match the expected instructions, generate a fault.

In step 1316, if the fetched instruction(s) do match the expected instruction(s), then the processor 202 executes the instructions corresponding to entry into execution of the ISR according to the second STACK 106. In an example, step 1316 corresponds to parallel execution of ISR1.PROT and ISR2.PROT. In step 1318, copy the second (inactive) STACK 106 pointer into the active STACK 106 register. In step 1320, the processor 202 executes the ISR corresponding to the protected interrupt.

FIG. 13B is a flow diagram of an example process 1322 for returning process control to a previously executing process after the processor 202 finishes executing an ISR in response to a protected interrupt according to FIG. 13A. In some examples, steps of the process 1322 are performed in the processor 202. In step 1324, the processor 202 receives and executes an instruction (such as RET1.RTINT) to return from the ISR corresponding to the protected interrupt.

In some examples, a protected exit instruction (accordingly, a two-way return handshake) is not required because the return address is taken from the protected interrupt stack 1200. A discontinuity corresponding to a protected call is part of designed software. Accordingly, a return handshake can be included in a corresponding code sequence. In some examples, for a protected call, the call handshake and return handshake are used to protect against faults or unauthorized execution that might occur due to (for example) accidental or targeted manipulation of processor registers 213 (such as the program counter) prior to executing a discontinuity instruction. (Similar reasons may apply to the handshake for a protected branch.) By contrast, a protected interrupt corresponds to an event outside normal operation.

In step 1326, the saved software context is popped off the protected interrupt stack 1200 at a memory location responsive to the ISP 1204, and corresponding information is reloaded into memory to enable the previously executing process to resume. In step 1328, the second (active) STACK 106 pointer is copied into the corresponding inactive STACK 106 register, and the first (inactive) STACK 106 pointer is copied from the corresponding register holding the inactive version of the first STACK 106 pointer into the active STACK 106 register. In step 1330, the processor 202 resumes executing the previously executing process.

In some examples, the processing system 200 also includes interrupts that are not protected interrupts. In some examples, these interrupts are also called low-priority interrupts or non-real-time interrupts. In some examples, low-priority interrupts correspond to background tasks. In some examples, low-priority interrupts are tracked, such as by a stack or list, during program execution, and their execution is deferred. When the program counter corresponds to a memory address associated (via an associated APR 102) with a designated source LINK 104, the tracked interrupts are executed. In some examples, each STACK 106 has a corresponding designated LINK 104 that will trigger execution of deferred low-priority interrupts. In some examples, LINKs 104 corresponding to ISRs for low-priority interrupts are associated (via respective APRs 102) with memory associated with a same STACK 106 as the designated trigger LINK 104 for those low-priority interrupts.

### IV. Debugging and Firmware Updating According to ZONEs

As described above, in some examples, different sections of code or data are owned by different parties, such as different third parties. ZONEs 108 divide code, data, and other resources in memory into separate domains enabling separate debug permissions and separate firmware update permissions, while also enabling heterogeneously owned code to be executed together as a single application.

When performing a debugging or firmware update operation (such as a Flash update), all LINKs 104 to which a user—accordingly, a ZONE 108—has corresponding debug permissions are treated as source LINKs 104. Accordingly, a ZONE 108 for which a user has provided valid authorization credentials, such as a valid login and password, can be described as a source ZONE 108. The APR 102 corresponding to the memory location targeted by a debug or firmware update instruction is the target APR 102. Translating a source ZONE 108 into its component source LINKs 104 enables use of the LINK 104 permissions entries in the target APR 102 to determine R/W permissions for debug or firmware update instructions.

Also, if the target APR 102 is within the source ZONE 108 (enabled for debug) and the execute permission bit of the target APR 102 is set to ENABLE (accordingly, the memory range associated with the target APR 102 stores executable code), then the memory access requested by the debug instruction will be permitted. Access is authorized on the basis of the execute bit because (in some examples) a primary function of debugging is to verify proper function of executable code, and to read and rewrite code that is not functioning properly. In some examples, ZONE-based debug permissions can be allocated according to different permissions principles than described herein (for example, additional considerations may be required to give permission according to an APR 102 execute bit).

FIG. 14 is a functional block diagram of an example system 1400 for determining permissions for a debug instruction according to the processing system 200 of FIG. 2. The system 1400 includes, for each of (1) a debug read logic and (2) a debug write logic: a multiplexer 1402, N two-input logical AND gates (N AND gates) 1404 where N is the number of LINKs 104 in the permissions association trees 101 of the processing system 200, a logical AND gate (AND gate) 1406, and a logical OR gate (OR gate) 1408. Debug instructions are routed to the debug read logic or the debug write logic in response to whether the debug instruction requests a read access or a write access. The system 1400 also uses the APR block 214 and the L/S/Z block 216, specifically, the LINK to STACK association configuration registers 222, the STACK to ZONE association configuration registers 224, the ZONE debug permission registers 226, and the decoder 230.

The decoder 230 controls the LINK to STACK association configuration registers 222, the STACK to ZONE association configuration registers 224, and the ZONE debug permission registers 226 for the purpose of determining ZONE-based debug permissions. Use of the decoder 230 to control the LINK to STACK and STACK to ZONE association configuration registers 222 and 224 to provide STACK 106 and ZONE 108 identifiers corresponding to a LINKID is described above with respect to FIG. 3A. The LINK to STACK association configuration registers 222 output, in a designed order so that each portion of the output (for example, N separate signals or N fields of a word) corresponds to one of the N available LINKs 104, an identifier for a STACK 106 corresponding to that LINK 104. The available LINKs 104 are, for example, each of the 16 LINKs 104 in the examples of FIGS. 1A and 1B. There are M available STACKs 106, for example, the 8 STACKs 106 in the examples of FIGS. 1A and 1B. Accordingly, the output of the LINK to STACK association configuration registers 222 translates from LINKn 104-n (of N LINKs 104) to STACKm 106-m (of M STACKS 106).

The STACK to ZONE association configuration registers 224 output, in a designed order (such as the same designed order as above) so that each portion of the output corresponds to one of the available LINKs 104, a ZONE 108 identifier corresponding to the respective received STACK 106 identifier. Outputs of the STACK to ZONE association configuration registers 224 are, for example, N separate signals or N fields of a word. The STACK to ZONE association configuration registers 224 output to the ZONE debug permission registers 226. There are P available ZONEs 108, for example, the 4 ZONEs 108 in the examples of FIGS. 1A and 1B. Accordingly, the output of the STACK to ZONE association configuration registers 222 translate from LINKn 104-n, according to the designed order, to ZONEp 108-p (of P ZONEs 108).

The ZONE debug permission registers 226 output a number N sets of permissions (for example, N separate signals or N fields of a word), each permission set corresponding to R/W permissions for a corresponding one of the available LINKs 104. Each permission set is output to a corresponding one of the first inputs of the N AND gates 1404, and to a corresponding one of the N inputs of the multiplexer 1402. Read permissions are provided to the debug read logic and write permissions are provided to the debug write logic. Permissions are determined by a set of credentials provided by a user corresponding to a ZONE 108, for example, a password or a challenge and response.

In some examples, the ZONE debug permission registers 226 provide permissions to one or more entire ZONEs 108, so that an example set of read permissions is 0010, corresponding to read permission granted to ZONE1 108-1 and not ZONE0 108-0, ZONE2 108-2, or ZONE3 108-3. In some examples, permissions can be granted to multiple ZONEs 108 at once, such as in response to a superuser credential.

The APR block 214 receives the target memory address for a debug instruction from the instruction pipeline 208, such as from a read stage 236 (see steps 338, 340, and 342 of FIG. 3C), via a debug port, such as a debug read bus or a debug write bus. The APR block 214 provides a set of permissions, each permission (such as a permission bit) provided to a corresponding second input of the N AND gates 1404. The APR block 214 provides a set of read permissions to the read logic and a set of write permissions to the write logic. The provided permissions are those stored by the target APR 102 associated with the target memory address for the available LINKs 104. Accordingly, a permission for LINKn 104-n is provided to an nth first input of the N AND gates 1404 by the ZONE debug permission registers 226, and a permission for LINKn 104-n is provided to an nth second input of the N AND gates 1404 by the APR block 214.

The APR block 214 provides the LINKID stored by the target APR 102 to a control input of the multiplexer 1402. The APR block 214 provides the execute permission bit stored by the target APR 102 to a first input of the AND gate 1406. The multiplexer 1402 outputs to a second input of the AND gate 1406. Accordingly, the AND gate 1406 outputs a logic one if the target APR 102 is associated with a LINK 104 granted debug permission by the currently credentialed ZONE 108, and is associated with memory storing executable code.

The N AND gates 1404 and the AND gate 1406 output to the OR gate 1408. The output of the OR gate 1408 corresponds to read or write permission for read or write logic, respectively.

At least one of the N AND gates 1404 in the read or write logic outputs a logic one if the target APR 102 grants read or write permissions (respectively) to a source LINK 104 to which the credentialed ZONE 108 grants read or write permission (respectively). Accordingly, the LINKs 104 to which the credentialed ZONE 108 grants permissions can be described as a set of source LINKs 104. If any of the source LINKs 104 are granted read permission by the debug target APR 102, then debug read is allowed according to the read logic. If any of the source LINKs 104 are granted write permission by the debug target APR 102, then debug write is allowed according to the write logic.

FIG. 15 is a flow diagram of an example process for determining permissions for a debug instruction according to the system of FIG. 14. In step 1502, receive and validate a set of user credentials corresponding to debug permissions for a particular ZONE 108. In step 1504, the decoder 230 controls determination of associations between each available LINK 104 and respective STACKs 106 using the LINK to STACK association configuration registers 222. In step 1506, the decoder 230 controls determination of associations between each available LINK 104 and respective ZONEs 108 using the STACK to ZONE association configuration registers 224.

In step 1508, look up per-ZONE 108 debug permissions corresponding to the validated user credentials in the ZONE debug permission registers 226. In step 1510, determine a set of per-LINK 104 debug permissions by correlating the per-ZONE 108 permissions determined in step 1508 to the LINKs 104 associated with the respective ZONEs 108 as determined in steps 1504 and 1506. In some examples, step 1510 is performed by the decoder 230 (accordingly, in some examples, the decoder 230 includes functionality in addition to determination of L/S/Z information).

In step 1512, look up the target memory address in the APR block 214 to find the permissions associated with each LINK 104 as stored by the target APR 102. In step 1514, compare the permissions stored for each LINK 104 by the target APR 102 to the per-LINK 104 debug permissions. In some examples, step 1514 is performed using the N AND gates 1404. In step 1516, compare the execute permission for the target APR 102 to the debug permissions for the target LINK 104. In some examples, step 1516 is performed using the multiplexer 1402 and the AND gate 1406.

In step 1518, if step 1514 indicates that a LINK 104 is granted per-ZONE 108 debug permission and is also granted R/W permission by the target APR 102, or step 1516 indicates that the target APR 102 allows execution and the target LINK 104 has debug permission, then perform the memory access requested by the debug instruction. In some examples, step 1518 is performed using the OR gate 1408.

FIG. 16 is a functional block diagram of an example system 1600 for determining permissions for and performing firmware updates according to the processing system 200 of FIG.

2. The firmware update controller 218 includes a firmware access controller 1602, firmware semaphore registers 1604, and an authorization unit 1606. The non-volatile memory controller 232 includes NVM registers 1608, an NVM state machine 1610, and NVM banks 1612 (one or more banks of non-volatile memory). For clarity, some structures and connections illustrated in FIG. 2 are not shown in FIG. 16. The firmware semaphore registers 1604 include an FLSEMREQ (Flash semaphore request) register 1614, an FLSEMSTAT (Flash semaphore status) register 1616, and an FLSEMCLR (Flash semaphore clear) register 1618.

The processor 202 is connected and configured to provide a firmware update data path control request or a firmware update directive fetched (by the processor 202) from the MAP block 206 to the firmware access controller 1602. A firmware update directive corresponds to an address, a data, and a command. The firmware access controller 1602 is communicatively connected to the firmware semaphore registers 1604 and is connected and configured to allow or disallow certain firmware-related messages from the processor 202 to the firmware update registers 1604 or the NVM registers 1608. Firmware-related messages from the processor 202 that the firmware access controller 1602 determines whether to allow include semaphore control requests, writes to the FLSEMCLR register 1618, and/or writes of firmware update directives to the NVM registers 1608. Accordingly, the processor 202 is connected to provide firmware-related messages to the firmware semaphore registers 1604 or the NVM registers 1608 via the firmware access controller 1602. A firmware update data path request is required to enable a source LINK 104 to provide authorized firmware update directives to the NVM registers 1608 via the firmware access controller 1602.

In some examples, such as if the NVM banks 1612 correspond to Flash memory, the command in a firmware update directive is a program command (program the data into the memory location corresponding to the address) or an erase command (reset the NVM memory in a sector corresponding to the address to all ones). In some examples, a data is not included if the command is an erase command. In some examples, Flash memory or a type of non-volatile memory other than Flash memory is used to store firmware. In some examples, other and/or additional commands are used. In some examples, the system 1600 (FIG. 16) and/or process 1700 (FIG. 17) described herein are used to reprogram (update) static data.

The firmware semaphore registers 1604 are communicatively connected to the authorization unit 1606. The NVM registers 1608 are connected to provide the address and command received from the processor 202 (via the firmware access controller 1602) to the NVM state machine 1610, and to provide the address and data received from the firmware access controller 1602 to the NVM banks 1612 responsive to control signals from the NVM state machine 1610 (after authorization confirmation from the authorization unit 1606). The NVM state machine 1610 is communicatively connected to the authorization unit 1606, and is connected to control the NVM banks 1612. Accordingly, the NVM state machine 1610 provides the address and command received from the NVM registers 1608 to the authorization unit 1606, and the authorization unit 1606 replies with authorization information. In some examples, the NVM state machine 1610 is connected to the authorization unit 1606 by a crossbar or a bus.

The authorization unit 1606 is communicatively connected to the firmware semaphore registers 1604 and the APR block 214 (in some examples, via the data access filter 217). The NVM state machine 1610 controls the NVM registers 1608 and the NVM banks 1612 responsive to authorization information provided by the authorization unit 1606. The authorization unit 1606 determines the authorization information it provides to the NVM state machine 1610 responsive to the ZONE update permission registers 228 and the firmware semaphore registers 1604. In particular, authorization information is determined by comparing a first LINKID of an authorized LINK 104 for a ZONE 108 corresponding to the address in a firmware update directive to a second LINKID of a LINK 104 that owns the firmware update data path. The (first) authorized LINK 104 LINKID is provided by the ZONE update permission registers 228. The (second) firmware data path owner LINK 104 LINKID is provided by the firmware semaphore registers 1604.

When the processor 202 begins a firmware update, it communicates with the firmware semaphore registers 1604 via the firmware access controller 1602 (accordingly, with the firmware update controller 218) to take control of a firmware update data path. Initially, responsive to a semaphore control request provided by a source LINK 104, the processor 202 writes to the FLSEMREQ register 1614 to request ownership of the firmware update data path. Only a source LINK 104 that owns the firmware update data path is allowed to control the processor 202 to send firmware update directives to the NVM registers 1608 (accordingly, to the non-volatile memory controller 232).

Ownership of the firmware update path is tracked by an FLSEMSTAT register 1616. The FLSEMSTAT register 1616 stores a TRUE/FALSE value indicating whether the firmware update data path is owned. If the FLSEMSTAT register 1616 stores TRUE, then the firmware update data path is owned, and if the FLSEMSTAT register 1616 stores FALSE, then the firmware update data path is not owned.

If the FLSEMSTAT register 1616 stores FALSE, the FLSEMSTAT register 1616 stores a LINKID corresponding to the source LINK 104 that controlled the processor 202 to provide the semaphore control request (firmware update data path control request) to the firmware access controller 1602, and changes the stored logic value to the TRUE value. That source LINK 104 is then allowed to send firmware update directives to the NVM registers 1608. If the FLSEMSTAT register 1616 already stores TRUE, then in response to a new semaphore control request, the semaphore control request is discarded (in some examples, a fault is generated).

On a read of the FLSEMSTAT register 1616, the LINKID of the source LINK 104 corresponding to that read is compared with the LINKID stored in the FLSEMSTAT register 1616. (In some examples, the CPUID of the processor 202 corresponding to the read is also compared to the CPUID stored in the FLSEMSTAT register 1616.) Responsively, the firmware access controller 1602 sends the processor 202 an indicator, such as a TRUE/FALSE indicator, describing whether the source LINK 104 LINKID and the LINKID stored in the FLSEMSTAT register 1616 (and/or corresponding CPUIDs) match. This enables code to instruct a read of the FLSEMSTAT register 1616 to determine whether a process (accordingly, a source LINK 104) corresponding to that code owns the firmware update data path, without the code knowing the LINKID associated with its corresponding process/source LINK 104.

Ownership of the firmware update data path can be relinquished if the LINK 104 corresponding to the LINKID stored by the FLSEMSTAT register 1616 (the current firmware update data path owner), acting as the current source LINK 104, writes to the FLSEMCLR register 1618. The firmware access controller 1602 checks the firmware semaphore registers 1604 to determine whether a LINKID of a source LINK 104 attempting to write to the FLSEMCLR register 1618 matches the LINKID stored by the FLSEMSTAT register 1616. If the LINKIDs do not match, the FLSEMCLR request 1618 is discarded (in some examples, a fault is generated). If the LINKIDs do match, the firmware access controller 1602 allows the write to the FLSEMCLR register 1618. This enables a different source LINK 104 to take ownership of the firmware update data path. Writing to the FLSEMCLR register 1618 controls the FLSEMSTAT register 1616 to set the TRUE/FALSE value it stores to FALSE. In some examples, the FLSEMSTAT register 1616 also clears the LINKID it stores (such as by setting the stored LINKID to a NULL value) in response to the FLSEMCLR register 1618 being written.

In some examples, the FLSEMSTAT register 1616 also stores a CPUID (identifier of a processor 202) that wrote to the FLSEMREQ register 1614 to take ownership of the firmware update data path. In some examples, the firmware access controller 1602 only allows the processor 202 and LINK 104 (acting together) that wrote to the FLSEMREQ register 1614 to take ownership of the firmware update data path and/or to write to the FLSEMCLR register 1618 to relinquish ownership of the firmware update data path.

In some examples, a root of trust LINK 104, such as LINK2 104 as described with respect to FIG. 1B, always has permission to provide a write request to the FLSEMCLR register 1618 (in addition to the firmware data path owner). Accordingly, in some examples, a specified processor 202 (such as CPU1) running root of trust code is provided global firmware update permissions. In some examples, a root of trust LINK 104 can write to the FLSEMCLR register 1618, such as if the CPU.LINK that owns the firmware update data path is unusable for that purpose, such as due to hardware or software error.

In response to a firmware update directive from the processor 202 to the NVM registers 1608, the firmware access controller 1602 compares the LINKID stored by the FLSEMSTAT register 1616 to the LINKID of the source LINK 104 that sent the firmware update directive. If the LINKIDs do not match or the FLSEMSTAT register 1616 stores FALSE, the firmware update directive is discarded (or, in some examples, a fault is generated). If the LINKIDs do match and the FLSEMSTAT register 1616 stores TRUE, the firmware access controller 1602 allows the firmware update directive (address, data, and command) to be written to the NVM registers 1608. In some examples, the firmware access controller 1602 also compares the CPUID of the processor 202 that sent the firmware update directive to a CPUID stored by the FLSEMSTAT register 1616 to determine whether to allow the processor 202 to write the firmware update directive to the NVM registers 1608.

As described, if the LINKID of the source LINK 104 that provides the firmware update directive to the firmware access controller 1602 matches the LINKID stored in the FLSEMSTAT register 1616 (accordingly, is the firmware update data path owner), then the firmware access controller 1602 writes the firmware update directive to the NVM registers 1608. The NVM registers 1608 provide the address and command included in the firmware update directive to the NVM state machine 1610, which provides that address and command to the authorization unit 1606.

The authorization unit 1606 provides the received address to the APR block 214. The APR block 214 determines the LINKID of a LINK 104 associated with the received address (via an associated APR 102), and provides that LINKID to the decoder in the L/S/Z block 216. The decoder 230 determines an identifier of a ZONE 108 associated with the received address responsive to the corresponding LINKID, the LINK to STACK association configuration registers 222, and the STACK to ZONE association configuration registers 224. The L/S/Z block 216 provides this ZONE 108 identifier, and the permissions information stored in the ZONE update permission registers 228, to the authorization unit 1606.

The authorization unit 1606 determines an authorized LINKID (and in some examples, an authorized CPUID), corresponding to a LINK 104 authorized to perform firmware updates on the identified ZONE 108, responsive to the ZONE 108 identifier and the received permissions information. In some examples, the received address corresponds to ZONE3 108-3, and permissions information for ZONE3 108-3 may indicate LINK5 (LINK5 104-5) or CPU1.LINK7 (LINK7 104-7 code executed by a processor 202 identified as CPU1). The firmware semaphore registers 1604 provide to the authorization unit 1606 an owner LINKID (and in some examples, an owner CPUID) of the firmware update data path owner as stored by the FLSEMSTAT register 1616. In some examples, the firmware update data path owner may be LINK5 or CPU1.LINK7 , corresponding to authorization granted for respective examples above, or LINK3 or CPU2.LINK8 corresponding to authorization denied for respective examples above.

The authorization unit 1606 compares the authorized LINKID (and/or CPUID) to the owner LINKID (and/or CPUID). If the LINKIDs (and/or CPUIDs) match, the authorization unit 1606 provides a TRUE signal to the NVM state machine 1610 indicating authorization for the NVM state machine 1610 to control the NVM banks 1612 to perform the firmware update directive. If the LINKIDs (and/or CPUIDs) do not match, the authorization unit 1606 provides a FALSE signal to the NVM state machine 1610 indicating that the firmware update directive should be discarded (in some examples, a fault is generated).

In some examples, such as if the firmware update directive commands a change to read margin mode or another security-sensitive command, the authorization unit 1606 adds an alternative or additional condition for its response to the NVM state machine 1610. In particular, the authorization unit 1606 additionally checks whether the LINKID of the source LINK 104 has permission to control the non-volatile memory controller 232 to execute the particular command (in some examples, on the particular address) specified by the firmware update directive. Otherwise, permission is denied. In some examples, a check for permission to perform a command type is to a source other than the ZONE update permissions registers 228.

If the NVM state machine 1610 receives affirmative (TRUE) authorization from the authorization unit 1606, then the NVM state machine 1610 controls the NVM banks 1612 according to the address, data, and command provided by the firmware update directive.

FIG. 17A is a first flow diagram of an example firmware update process 1700 according to the system 1600 of FIG. 16. FIG. 17A is continued in FIGS. 17B and 17C. FIG. 17A shows a first portion 1700a of the process 1700, FIG. 17B shows a second portion 1700b of the process 1700, and FIG. 17C shows a third portion 1700c of the process 1700.

Here, x is an identifier of an available LINK 104. With respect to description of the process 1700, actions taken by the system 1600 responsive to code fetched from memory associated with source LINKx 104-x (via respective associated APRs 102) will be referred to as responsive to the source LINKx 104-x. In step 1702, a source LINKx 104-x controls the processor 202, responsive to a semaphore control request, to write to the FLSEMREQ register 1614 to request ownership of the firmware update data path.

In step 1704, the firmware access controller 1602 checks whether the FLSEMSTAT register 1616 indicates that the firmware update data path is available for ownership, accordingly, whether the FLSEMSTAT register 1616 stores FALSE. If the FLSEMSTAT register 1616 stores TRUE (not available), then in step 1706 the semaphore control request is discarded and the process 1700 proceeds to step 1710. If the FLSEMSTAT register 1616 stores FALSE (available), then in step 1708, the firmware access controller 1602 writes TRUE and the LINKID of the source LINKx 104-x to the FLSEMSTAT register 1616.

In step 1710, the source LINKx 104-x controls the processor 202 to read the FLSEMSTAT register 1616 to confirm ownership of the firmware update data path. Ownership of the firmware update data path is confirmed if the LINKID of the source LINKx 104-x matches the LINKID of the FLSEMSTAT register 1616, and the FLSEMSTAT register 1616 stores TRUE. Ownership of the firmware update data path is not confirmed if the LINKIDs do not match or the FLSEMSTAT register 1616 stores FALSE. In some examples, to confirm firmware update data path ownership, a CPUID of the processor 202 processing the source LINKx 104-x must also match a CPUID stored by the FLSEMSTAT register 1616.

In step 1712, if ownership of the firmware update data path by LINKx 104-x is confirmed, corresponding to the FLSEMSTAT register 1616 read returning a LINKID that matches the LINKID of the source LINKx 104-x, the process 1700 proceeds to step 1714. Otherwise, the source LINKx 104-x controls the processor 202 to return to step 1702. In some examples, on failure by the source LINKx 104-x to take ownership of the firmware update data path, the source LINKx 104-x aborts the firmware update attempt and execution proceeds along a different path.

In step 1714, the source LINKx 104-x controls the processor 202 to provide a firmware update directive to the NVM registers 1608 via the firmware access controller 1602. In step 1716, the firmware access controller 1602 determines whether the source LINKx 104-x owns the firmware update data path. This determination is further described above with respect to step 1712. If LINKx 104-x does not own the firmware update data path, then in step 1718, the firmware update directive is discarded. In some examples, further execution is code dependent. If LINKx 104-x does own the firmware update data path, then in step 1720, the firmware access controller 1602 writes the firmware update directive to the NVM registers 1608.

FIG. 17B is a second flow diagram continuing the example firmware update process 1700 according to the system 1600 of FIG. 16. As described above, FIG. 17B shows a second portion 1700b of the process 1700.

In step 1722, the NVM registers 1608 provide the address and command included in the firmware update directive to the NVM state machine 1610. In step 1724, the NVM state machine 1610 provides the address and command to the authorization unit 1606. In step 1726, the authorization unit 1606 requests the APR block 214 and L/S/Z block 216 to provide the ZONE 108 update permissions stored by the ZONE update permissions registers 228, and a ZONE 108 corresponding to the received address. In step 1728, the authorization unit 1606 determines, responsive to the received ZONE 108 and ZONE 108 update permissions, a LINKy 104-y that is authorized to control firmware updates of the address targeted by the firmware update directive. Here, y is an identifier of an available LINK 104.

In step 1730, the authorization unit 1606 controls the firmware semaphore registers 1604 to provide the LINKID of the LINKx 104-x that owns the firmware update data path. In step 1732, the authorization unit 1606 compares the LINKID of LINKx 104-x to the LINKID of LINKy 104-y. If the LINKIDs do not match, then in step 1734, the authorization unit 1606 denies the NVM state machine 1610 authorization (such as by a FALSE signal) to execute the firmware update directive, and the firmware update directive is discarded, and further execution is code dependent. If the LINKIDs do match, then in step 1736, the authorization unit 1606 provides the NVM state machine 1610 authorization (such as a TRUE signal) to execute the firmware update directive. In step 1738, the NVM state machine 1610 controls the NVM banks 1612 to execute the firmware update directive.

FIG. 17C is a third flow diagram continuing the example firmware update process 1700 according to the system 1600 of FIG. 16. As described above, FIG. 17C shows a third portion 1700c of the process 1700.

In step 1740, if there are additional firmware update directives to be processed according to the current owner (LINKx 104-x) of the firmware update data path, the process 1700 returns to step 1714 (in FIG. 17A). Otherwise, in step 1742, the source LINKx 104-x controls the processor 202 to provide a write request to the FLSEMCLR register 1618 to release firmware data path ownership. In step 1744, the firmware access controller 1602 determines whether the source LINKx 104-x owns the firmware update data path. This determination is further described above with respect to step 1712. In step 1746, if the source LINKx 104-x does not own the firmware update data path, the FLSEMCLR register 1618 write request is discarded and further execution is code dependent. In step 1748, if the source LINKx 104-x owns the firmware update data path, the FLSEMCLR register 1618 is written with a value that causes a firmware update data path ownership value stored by the FLSEMSTAT register 1616 to be set to FALSE.

Modifications are possible in the described examples, and other examples are possible within the scope of the claims.

In some examples, different, additional, or fewer processing system 200 components or system 1600 components are used than described herein. In some examples, a data path is routed differently than described herein. In some examples, configuration settings and/or other data and/or instructions are stored in different memory than described herein.

In some examples, two or more copies of a decoder 230 logic for using the LINK to STACK and/or STACK to ZONE association configuration registers 222 and/or 224 to translate a LINKID (or other LINK 104 identifier) to an identifier of an associated STACK 106 and/or an identifier of an associated ZONE 108 are included in an L/S/Z block 216. Including two or more copies of this decoder 230 logic enables certain processes described herein to be performed in parallel. For example, determination of STACK 106 and ZONE 108 information responsive to an instruction being fetched by a fetch stage 231 (for example, FIG. 2 and steps 310 and 312 in FIG. 3), and determination of a ZONE 108 identifier responsive to a firmware update directive provided by the processor 202, may be performed in parallel using multiple copies of the decoder 230 logic. In some examples, determining L/S/Z information for debug authorization, such as in the process 1500, may correspond to or require a separate decode 230 logic to enable performance in parallel with other processes that use the decode 230 logic.

In some examples, the processor registers 213 (or other memory) include one or more registers that can be written, responsive to code (software), with a memory address. The decoder 230 logic can be used to determine a LINK 104, STACK 106, and ZONE 108 corresponding to the memory address stored in the processor register 213, and store this information in another processor register 213 (or other memory). In some examples, one or more of the processor registers 213 for storing a memory address is writable by software, and one or more of the processor registers 213 for storing a memory address is writable by a debugger. In some examples, these or other processes (such as parallel performance examples above) may correspond to or require respective separate decode 230 logic to avoid overwriting L/S/Z information determined by an instance of the decode 230 logic responsive to another process.

In some examples, global variables are stored in a memory range associated with a LINK 104 (via an APR 102) to which all other LINKs 104 (or all other LINKs 104 that should have access to global variables) are allowed read and/or write access.

In some examples, the processor 202 provides data corresponding to less than all of an instruction to the APR block 214 for determination of permissions. In some examples, a copy of a memory access request sent (or to be sent) to the MAP block 206 is sent to the APR block 214 for determination of permissions.

In some examples, data and/or instructions from the MAP block 206 are routed to the processor 202 via (through) the APR block 214 or the data access filter 217. In some examples, the data access filter 217 performs zeroing out of read data or instructions that do not have required permissions, as determined responsive to a corresponding APR 102.

In some examples, the L/S/Z registers 212 also include registers for storing an identifier of a source APR 102. In some examples, the source APR 102 identifier is forwarded to the processor 202 from the APR block 214 via the L/S/Z block 216.

In some examples, an instruction fetch uses the PRAB, the PRDB, and/or one or more control/sideband signals.

In some examples, a stage 210 processing an instruction can include the stage 210 passively holding the instruction to be passed to the next stage 210. For example, the execute stage may have little or nothing to do with a write instruction other than to receive it from the read stage 236 and pass it to the write stage 240.

In some examples, ZONEs 108 can be described as associated with respective groups of one or more LINKs 104 (such as via respective associated STACKs 106).

In some examples, one or more of LINKs 104, STACKs 106, or ZONEs 108 is not included in a processing system 200.

In some examples, calls between LINKs 104 within a same STACK 106 do not require particular STACK 106 entry instructions or STACK 106 exit instructions.

In some examples, a cross-STACK 106 discontinuity such as protected call or protected branch instruction, or a cross-STACK 106 return instruction such as EXIT.PROT, can be described as a STACK 106 exit instruction. In some examples, an instruction for entering execution according to a STACK 106 such as an ENTRY1.PROT, ENTRY2.PROT, or RET.PROT, can be described as a STACK 106 entry instruction.

In some examples, a semiconductor die includes multiple processors 202 that share an SSU 204.

In some examples, different processors 202 (or other processors) fabricated on a semiconductor die have their own respective SSUs 204 enabling some or all of the functions described above. In some examples, such separate SSUs 204 share certain memory, such as firmware semaphore registers 1604.

In some examples, processes described herein are performed using software, hardware, or a combination of software and hardware.

In some examples, registers used to store APR 102 R/W permissions can be described as similar to memory protection unit (MPU) registers.

In some examples, R/W permissions corresponding to a single LINK 104, as stored by an APR 102, use two bits. For example, one bit indicating yes/no read permission, and one bit indicating yes/no write permission. In some examples, R/W permissions for all available LINKs 104, as stored by an APR 102, use 2N bits, where N is the number of LINKs 104.

In some examples, a number of bits used for a LINKID is log₂N, where N is the number of LINKs 104. In some examples, a number of bits used to identify a STACK 106 is log₂M and a number of bits used to identify a ZONE 108 is log₂P, where M and P are the numbers of STACKs 106 and ZONEs 108, respectively.

In the above description, some aspects are described with respect to, and/or certain information is described as being stored in, particular types of memory, such as Flash memory or RAM. In some examples, different types or regions of memory than described herein can be used to store information described herein, such as information in or related to APRs 102, LINKs 104, STACKs 106, and ZONEs 108.

In some examples, memory address ranges can be allocated to LINKs 104 non-contiguously. In some examples, there is unallocated memory between LINKs 104.

In some examples, on reset, a processor 202 boots using code corresponding to a selected STACK 106. For example, a processor 202 can boot using designer-owned ROM code in STACK0 106, or using customer-owned user code in STACK2 106.

In some examples, a processor 202 boots using code stored in memory associated (via associated APRs 102) with a root of trust LINK 104.

In some examples, entry into execution according to a STACK 106 begins with execution of a single entry instruction. In some examples, entry into execution according to a STACK 106 begins with execution of more than two entry instructions executed in parallel.

In some examples, inactive stack pointers are stored in protected processor registers 213 that cannot be modified by code unless that code is stored in memory associated with a root-of-trust LINK 104. In some examples, only allowing inactive stack pointers to be modified by the root-of-trust LINK 104 corresponds to debugging inactive stack pointers requiring permissions for a ZONE 108 associated with the root-of-trust LINK 104.

In some examples, an active stack pointer can be modified by code. Accordingly, in such examples, the active stack pointer can be modified by code stored in memory associated with the STACK 106 indexed by that active stack pointer.

In some examples, global variables are stored at any location in a memory, and may be stored out of order or non-contiguously. In some examples, stack data and global data are accessed using their addresses. In some examples, stack data uses an offset to the current stack pointer's current value to reference the address of a stack data. In some examples, a literal address for a global data (directly referencing the memory address at which the global data is stored, without use of an offset) is included in the instruction, or is stored in a processor register 213. In some examples, access requests for global data and stack data are sent using a data bus of the processor 202, such as the DRAB or the DRDB.

In some examples, debug permissions may be specified at lower level, such as per APR 102, though this may incur an additional memory overhead. In some examples, there is an additional level of decoding to translate from APR 102 level permissions to ZONE 108 level permissions. For example, APR 102 to LINK 104 association configuration registers can be used to decode from APR 102 identifiers to LINK 104 identifiers. In some examples, an APR 102 identifier is used to select an output of the multiplexer, such as where the output of the ZONE debug permission registers 226 is per APR 102.

In some examples, debug access permissions are granted per LINK 104 or per STACK 106.

In some examples, a firmware update owner configuration specifies one or more memory ranges (or APRs 102, LINKs 104, or STACKs 106) within a ZONE 108 to which a corresponding processor 202 and LINK 104 are granted firmware update permissions.

In some examples, each ZONE 108 has a firmware update owner configuration, or corresponds to a respective portion of a firmware update owner configuration, that determines a set of LINKs 104 that are allowed to be source LINKs 104 for firmware update directives that are allowed to update each memory region that is associated with an (for example, any) APR 102 within that ZONE 108. In some examples, the set of LINKs 104 permitted to be source LINKs 104 for firmware updates for a particular ZONE 108 are specified according to their respective LINKIDs.

In some examples, a non-NULL value of a LINKID of a source LINK 104 and/or CPUID of a processor 202 (or corresponding indicator(s) of such LINK 104 and/or processor 202) that owns the firmware update data path stored in the FLSEMSTAT register 1616 indicates firmware data path ownership, and a NULL value stored in the FLSEMSTAT register 1616 indicates that the firmware update data path is available for ownership to be taken.

In some examples, the firmware access controller 1602 is part of a memory block of the SSU 204 that includes the firmware semaphore registers 1604.

In some examples, a data path from the processor 202 to the firmware semaphore registers 1604 and/or to the NVM registers 1608 is controlled by, but is not routed through, the firmware access controller 1602.

In some examples, the firmware access controller 1602 does not determine whether to allow or disallow read requests from the processor 202 to the FLSEMSTAT register 1616.

In some examples, the firmware update owner configuration also specifies which processor 202 of multiple processors 202 within a system or fabricated together on a semiconductor die are allowed to provide firmware update directives that are granted firmware update permission for a specified ZONE 108 (a ZONE 108 corresponding to a firmware update owner configuration). In some examples, firmware update permissions for a source LINK 104 are specified as a CPU.LINK code, accordingly, a code that specifies a particular processor 202 and a particular source LINK 104.

In some examples, the NVM state machine 1610 controls programming and erasing of the NVM banks 1612, and the NVM registers 1608 control the NVM state machine 1610.

In some examples, a firmware update owner configuration of a first ZONE 108 can grant permissions for firmware updates to software code stored in a memory range associated with an APR 102 and corresponding source LINK 104 in a second ZONE 108. In some examples, the first ZONE 108 is different from or the same as the second ZONE 108. Accordingly, permissions association trees 101 and/or the processing system 200 of FIG. 2, with firmware update owner configuration, enable(s) configurable specification of which code is allowed to perform firmware update of code owned by a specified user (accordingly, a specified ZONE 108).

The term “couple” is used throughout the specification. The term may cover connections, communications, or signal paths that enable a functional relationship consistent with this description. For example, if device A provides a signal to control device B to perform an action, in a first example device A is coupled to device B, or in a second example device A is coupled to device B through intervening component C if intervening component C does not substantially alter the functional relationship between device A and device B such that device B is controlled by device A via the control signal provided by device A.

In this description, the term “and/or” (when used in a form such as A, B and/or C) refers to any combination or subset of A, B, C, such as: (a) A alone; (b) B alone; (c) C alone; (d) A with B; (e) A with C; (f) B with C; and (g) A with B and with C. Also, as used herein, the phrase “at least one of A or B” (or “at least one of A and B”) refers to implementations including any of: (a) at least one A; (b) at least one B; and (c) at least one A and at least one B.

A device that is “configured to” perform a task or function may be configured (for example, programmed and/or hardwired) at a time of manufacturing by a manufacturer to perform the function and/or may be configurable (or re-configurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal”, “node”, “interconnection”, “pin”, “ball” and “lead” are used interchangeably. Unless specifically stated to the contrary, these terms are generally used to mean an interconnection between or a terminus of a device element, a circuit element, an integrated circuit, a device or other electronics or semiconductor component.

While certain elements of the described examples may be included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

What is claimed is:

1. An integrated circuit (IC) comprising:
a memory configured to store instructions; and
a processor device coupled to the memory and configured to execute the instructions, the processor device configured to:
execute a discontinuity instruction that corresponds to a transition from execution according to a first stack pointer to execution according to a second stack pointer, wherein the discontinuity instruction specifies a destination address;
determine whether the destination address stores an entry instruction that corresponds to the discontinuity instruction; and
based on the destination address storing the entry instruction, begin execution at the destination address.

2. The IC of claim 1,
wherein the entry instruction is a first entry instruction; and
wherein the processor device is configured to:
determine whether a second entry instruction is stored proximate to the first entry instruction; and
begin the execution at the destination address further based on the second entry instruction being stored proximate to the first entry instruction.

3. The IC of claim 1, wherein the processor device is configured to generate a fault based on the destination address not storing the entry instruction.

4. The IC of claim 1, wherein the processor device is configured to:
based on the discontinuity instruction, copy the first stack pointer from an active stack register to a register storing an inactive version of the first stack pointer; and
based on the destination address storing the entry instruction, copy the second stack pointer from a register storing an inactive version of the second stack pointer to the active stack register.

5. The IC of claim 4, wherein one or more of the copy of the first stack pointer action, the copy of the second stack pointer action, or the determine action is performed as a hardware process.

6. The IC of claim 1, wherein:
the processor device is associated with an instruction set; and
the entry instruction is distinct from each other combination of instruction and/or data in the instruction set.

7. The IC of claim 1, wherein the entry instruction is a first entry instruction, and wherein the processor device is configured to:
execute a return instruction corresponding to the discontinuity instruction;
determine whether a return address corresponding to the return instruction stores a second entry instruction that corresponds to the return instruction; and
based on the return address storing the second entry instruction, begin execution at the return address.

8. The IC of claim 7, wherein the processor device is configured to:
based on the return instruction, copy the second stack pointer from an active stack register to a register storing an inactive version of the second stack pointer; and
based on the destination address storing the second entry instruction, copy the first stack pointer from a register storing an inactive version of the first stack pointer to the active stack register.

9. The IC of claim 1, wherein the discontinuity instruction is a call or a branch.

10. An integrated circuit (IC) comprising:
a first memory having a set of memory ranges;
a second memory configured to store configuration information associating each stack of a set of stacks with a respective subset of the set of memory ranges; and
a processor device including pipeline stages and configured to execute programmable instructions, the processor device configured to:
fetch a first instruction from the first memory;
determine a first stack of the set of stacks corresponding to the first instruction;
compare the first stack associated with the first instruction to a second stack associated with a second instruction being processed by the pipeline stages; and
execute the first instruction based on the first stack matching the second stack.

11. The IC of claim 10, wherein the processor device is configured to, based on the first stack not matching the second stack:
determine whether the second instruction is a discontinuity instruction;
determine whether the first instruction is a stack entry instruction corresponding to the discontinuity instruction; and
switch from execution according to the second stack to execution according to the first stack based on the second instruction being a discontinuity instruction and the first instruction being a stack entry instruction corresponding to the discontinuity instruction.

12. The IC of claim 11, wherein the processor device is configured to generate a fault based on the second instruction not being a discontinuity instruction or the first instruction not being a stack entry instruction corresponding to the discontinuity instruction.

13. The IC of claim 12, wherein comparing the first stack to the second stack includes determining a first stack indicator of the first stack and a second stack indicator of the second stack, and comparing the first stack indicator to the second stack indicator.

14. The IC of claim 13, further comprising:
a set of access protection registers (APRs) that each specify permissions for a respective associated memory range of the set of memory ranges and that each store an indicator for a group of a set of groups, the specified permissions indicating read/write permissions for instructions executed from memory ranges associated with each of the groups of the set of groups via the APRs storing the indicators for respective ones of the groups of the set of groups;
wherein the second memory stores associations between indicators of the stacks and indicators for one or more of the groups of the set of groups, so that each group of the set of groups is associated with exactly one stack.

15. The IC of claim 14, further comprising a decoder circuit configured to:
determine an APR associated with a portion of the set of memory ranges from which the first instruction was fetched; and
store the indicator of the group of the set of groups stored by the APR in a pipeline memory corresponding to a pipeline stage corresponding to the first instruction.

16. The IC of claim 14,
further comprising multiple decoder circuits, respective decoder circuits configured to determine a stack indicator of a stack associated with a particular group of the set of groups in response to an indicator of the particular group of the set of groups; and
wherein the processor device is configured to execute in parallel multiple processes that use the decoder circuit to determine one or more of a group of the set of groups indicator or a stack indicator.

17. The IC of claim 10, wherein respective stacks store, for execution according to the respective stack, one or more of: arguments, local variables, processor device state data, pointers to variables, pointers to memory addresses of variables, structures, or constants.

18. An integrated circuit (IC) comprising:
a memory configured to store instructions;
an active stack register;
a first inactive stack register;
a second inactive stack register; and
a processor device coupled to the memory and configured to execute the instructions, the processor device configured to:
execute a discontinuity instruction that is associated with a return instruction and that corresponds to transition from execution using a first stack pointer to execution using a second stack pointer;
copy the first stack pointer from the active stack register to the first inactive stack register responsive to the discontinuity instruction;
copy a return address from a program counter register and a return program counter (RPC) address from an RPC register to a stack responsive to the discontinuity instruction; and
copy the second stack pointer from the second inactive stack register to the active stack register and begin execution using the second stack pointer, responsive to the discontinuity instruction.

19. The IC of claim 18, wherein the processor device is configured to:
execute a return instruction corresponding to the discontinuity instruction;
copy the second stack pointer from the active stack register to the second inactive stack register, responsive to the return instruction;
copy the return address from the stack to the program counter register and copy the RPC address from the stack to the RPC register; and
copy the first stack pointer from the first inactive stack register to the active stack register and begin execution using the first stack pointer.

20. The IC of claim 18,
wherein the memory includes a protected stack pointer (PSP) and a maximum PSP;
wherein the processor device is configured to:
iterate the PSP in response to copying the return address and RPC address to the stack;
decrement the PSP in response to copying the return address and RPC address from the stack; and
generate an interrupt in response to the PSP and the maximum PSP.

21. The IC of claim 18, wherein the processor device is configured to prevent the stack from being modified other than according to the discontinuity instruction that transfers execution control from the first stack pointer to the second stack pointer, or according to a return instruction that returns execution control from the second stack pointer to the first stack pointer, or according to root-of-trust software.

22. The IC of claim 18,
wherein the memory is a first memory, and the first memory has a set of memory ranges;
further comprising a second memory configured to store configuration information associating each of the first and second stack pointers with a different, separate subset of the set of memory ranges;
wherein execution according to a particular stack pointer corresponds to execution of instructions stored within the subset of the memory ranges associated with the particular stack pointer.

23. The IC of claim 18, wherein each of the first and second stack pointers corresponds to a stack that is configured to store one or more of: arguments, local variables, processor device state data, pointers to variables, pointers to memory addresses of variables, structures, or constants.
